(19) United States
(12) Patent Application Publication
(10) Pub. No.: US 2019/0277524 A1
(43) Pub. Date: Sep. 12, 2019

(54) METHOD AND SYSTEM FOR SCHEDULE-BASED CONTROL OF A HVAC SYSTEM

(71) Applicant: Q-LINKS HOME AUTOMATION INC., Montreal (CA)

(72) Inventors: Frantz SAINTELLEMY, Montreal (CA); Chengyu TU, Montreal (CA); Kun YUAN, Montreal (CA); Van-Phuoc DO, Montreal (CA)

(21) Appl. No.: 16/423,460

(22) Filed: May 28, 2019

Related U.S. Application Data
(63) Continuation of application No. 15/557,707, filed on Sep. 12, 2017.
(60) Provisional application No. 62/132,817, filed on Mar. 13, 2015.

(51) Int. Cl. F24F 11/30; G05B 19/042; F24F 11/62; G05D 23/19

(52) U.S. Cl. CPC F24F 11/30; G05B 19/0426; F24F 11/64; G05D 23/1904; F24F 11/62

(57) ABSTRACT

There is provided a thermostat system comprising a HVAC interface module for controlling an external HVAC system; at least one of a wide-area communication module for data communication with an external network and a local communication module for data communication over a home automation network; and a processor configured for: receiving selection of an in-use schedule dataset; receiving environmental control rules; and controlling the HVAC interface module based on the in-use schedule dataset and the environmental control rules. Methods for controlling a HVAC system are also provided.

### CROSS REFERENCE TO RELATED APPLICATIONS

The present application is a continuation application of U.S. Ser. No. 15/557,707 filed on Sep. 12, 2017 that is a 35 USC 371 national stage entry of PCT/CA2016/050269 filed on Mar. 11, 2016 and which claims priority to U.S. 62/132,817 filed on Mar. 13, 2013. These documents are hereby incorporated by reference in their entirety.

### FIELD OF THE DISCLOSURE

The present disclosure relates to a system and method for controlling of a HVAC system, and more particularly a method and system in which the control of a HVAC system is schedule-based.

### BACKGROUND OF THE DISCLOSURE

Traditional thermostats known in the art are operable to monitor environmental conditions of an area of a building and control the heating, ventilation, and air condition system (“HVAC system”) of the building based on the sensed condition. Typically, the thermostat allows a user to set a desired temperature as a setpoint and the thermostat will control the HVAC system so that the setpoint temperature is maintained at the area of the building. Control is provided by making a heating call or a cooling call to the HVAC system.

More advanced thermostats allow programming of a thermostat so as to follow a preprogrammed schedule. For example, different setpoints can be set for different times of the day and the thermostat will control the HVAC system so as to maintain those setpoints at the different times. Even more modern thermostats allows the thermostat to be accessed remotely, such as over the internet via a mobile device, so as to vary the setpoint or monitor indoor conditions from a remote location.

Building automation or home automation pertains to the automated control of various devices found within the building home. Devices being automatically controlled include lighting, appliances, security systems, access systems (ex: locks), HVAC systems, etc.

### SUMMARY

It would thus be highly desirable to be provided with a device, system or method that would at least partially address the disadvantages of the existing technologies.

The embodiments described herein provide in one aspect a thermostat system comprising a HVAC interface module for controlling an external HVAC system, at least one of a wide-area communication module for data communication with an external network and a local communication module for data communication over a home automation network, and a processor. The processor is configured for receiving selection of an in-use schedule dataset, receiving environmental control rules and controlling the HVAC interface module based on the in-use schedule dataset and the environmental control rules.

The embodiments described herein provide in another aspect a thermostat system comprising a HVAC interface module for controlling an external HVAC system, at least one of a wide-area communication module for data communication with an external network and a local communication module for data communication over a home automation network and a processor. The processor is configured for receiving a currently-in-use schedule, receiving environmental control rules for controlling the external HVAC system, receiving via at least one of the wide-area communication module and the local communication module schedule information of a remote device associated to the thermostat system, determining from the received schedule information an event entry, modifying the currently-in-use schedule based on the determined event entry, thereby generating a modified currently-in-use schedule and controlling the HVAC interface module based on the modified currently-in-use schedule and the environmental control rules.

The embodiments described herein provide in yet another aspect a method for controlling a HVAC system, the method comprising, receiving selection of an in-use schedule data set, receiving environmental control rules and controlling a HVAC interface module of the HVAC system based on the in-use schedule dataset and the environmental control rules.

The embodiments described herein provide in yet another aspect a method for controlling a HVAC system, the method comprising receiving a currently-in-use schedule, receiving environmental control rules for controlling the HVAC system, receiving via at least one of a wide-area communication module and a local communication module schedule information of a remote device associated to the thermostat system, determining from the received schedule information an event entry, modifying the currently-in-use schedule based on the determined event entry, thereby generating a modified currently-in-use schedule and controlling an HVAC interface module based on the modified currently-in-use schedule and the environmental control rules.

The embodiments described herein provide in yet another aspect a non-transitory computer readable medium comprising a plurality of instructions for performing a method for controlling a HVAC system, wherein the instructions, when executed, configure a processor to receive selection of an in-use schedule data set, receive environmental control rules and control a HVAC interface module of the HVAC system based on the in-use schedule dataset and the environmental control rules.

The embodiments described herein provide in yet another aspect a non-transitory computer readable medium comprising a plurality of instructions for performing a method for controlling a HVAC system, wherein the instructions, when executed, configure a processor to receive a currently-in-use schedule, receive environmental control rules for controlling the HVAC system, receive via at least one of a wide-area communication module and a local communication module schedule information of a remote device associated to the thermostat system, determine from the received schedule information an event entry, modify the currently-in-use schedule based on the determined event entry, thereby generating a modified currently-in-use schedule and controlling an HVAC interface module based on the modified currently-in-use schedule and the environmental control rules.

### DRAWINGS

The following drawings represent non-limitative examples in which:

FIG. 1 illustrates a schematic diagram of a thermostat-controlled home automation system according to one exemplary embodiment;

FIG. 2 illustrates a schematic diagram of the operational modules of a thermostat system according to one exemplary embodiment;

FIG. 3 illustrates a schematic circuit diagram of exemplary operative connections between an HVAC interface module and a HVAC system during a heating call;

FIG. 4 illustrates a schematic circuit diagram of exemplary operative connections between an HVAC interface module and a HVAC system during a cooling call;

FIG. 5 illustrates a schematic diagram of a home automation system according to one exemplary configuration;

FIG. 6 illustrates a schematic diagram of the operational module of a thermostat system according to one variant exemplary embodiment;

FIG. 7 illustrates a schematic diagram of a home automation system according to one exemplary configuration;

FIG. 8 illustrates a schematic diagram of a home automation system according to one exemplary configuration;

FIG. 9 illustrates a schematic diagram of a home automation system according to one exemplary configuration;

FIG. 10 illustrates a schematic diagram of a home automation system according to one exemplary configuration;

FIG. 11 illustrates an exploded view of a thermostat system being provided in an enclosure according to one exemplary embodiment;

FIG. 12 illustrates a schematic diagram of an exemplary data structure of a schedule dataset for controlling a HVAC system;

FIG. 13 illustrates a schematic diagram of an exemplary data structure of a plurality of environmental control rules datasets for controlling a HVAC system;

FIG. 14A illustrates a flowchart showing the operational steps of an exemplary method for controlling a HVAC system;

FIG. 14B illustrates a flowchart showing the operational steps of another exemplary method for controlling a HVAC system;

FIG. 14C illustrates a flowchart showing the operational steps of another exemplary method for controlling a HVAC system;

FIG. 14D illustrates a flowchart showing the operational steps of an exemplary method for controlling a HVAC system;

FIG. 15 illustrates a flowchart showing the operational steps of an exemplary method for controlling a HVAC system; and

FIG. 16 illustrates a flowchart showing the operational steps of an exemplary method for controlling a HVAC system.

### DESCRIPTION OF VARIOUS EMBODIMENTS

The following examples are presented in a non-limiting manner.

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices are directly connected to one another or connected to one another through one or more intermediate elements or devices via an electrical element, electrical signal or a mechanical element depending on the particular context.

“Home automated device” herein refers to a device found within a building that can be at least partially accessed in an automated way. The device may be a piece of equipment in the building that can be operated to effect a change in the condition of the building. The device may be operable to sense one or more conditions of the building, such as one or more environmental conditions. The device may also be any device located within the building and that may be operated in different modes. The home automated device may be controlled to cause a change in an operational mode of the device. Additionally, or alternatively, the home automated device may provide information pertaining to a condition within the building or to a status of the home automated device. For example, a status of the home automated device may be on/off status, usage, or current operational mode. Accessing a home automated device refers to controlling the device, receiving information from the device, or both. It will be understood that while the word “home” has been used, home automated device may also include devices found in residential as well as non-residential buildings (ex: commercial or industrial buildings).

“Automation”, “automated” or variants, thereof refers to a way of accessing a device without real-time human intervention. For example, automated access may include where the access of a device is carried out so as to achieve a predefined requirement (ex: achieving a given setpoint). For example, automated access may also include where the access follows a predefined scheme (ex: various setpoints over time).

The expression “home automation network” herein refers to a local area network in which home automated devices and a thermostat system are nodes of the network. The home automated devices communicate with one another or with the accessing devices using a network protocol, such as Ethernet, ZigBee, Z-Wave, Bluetooth or Wi-Fi. The local area network can be wireless, wired or a mixture thereof.

“Networked home automated devices” or “network connected home automated devices” herein refers to home automated devices that are nodes of the home automation network.

“Directly-connected home automated devices” herein refers to home automated devices that communicate directly with the thermostat system independently of the home automation network. For example, a directly-connected home automated device may be hard-wired with the thermostat system.

According to example systems and methods disclosed herein, the systems and method further include receiving a selection of a modifier dataset modifying the in-use schedule dataset based on the selected modifier dataset, and controlling the HVAC interface module is based on the in-use schedule dataset as modified based on the selected modifier dataset.

According to example systems and methods disclosed herein, the modifier dataset defines modifications to at least two non-contiguous and non-recurring time periods of the base schedule.

According to example systems and methods disclosed herein, the in-use schedule defines a plurality of normal days and a plurality of special days, the at least two non-contiguous and non-recurring time periods defines at least two special days, modifying the base schedule comprises adding the at least two special days to the in-use schedule; and the environmental control rules comprises a first set of rules for controlling the HVAC system on normal days and a second set of rules for controlling the HVAC system on special days.

According to example systems and methods disclosed herein, the in-use schedule dataset defines a plurality of time interval entries each defining an interval of real-world time, the environmental control rules comprises a plurality of environmental control rule datasets each defining at least one control setpoint for at least one sub-interval of time; and the systems and methods further include associating each of the plurality of time interval entries to one of the environmental control rule datasets; and

wherein controlling the HVAC interface module comprises controlling the HVAC interface module during a given interval of real-world time defined by a given time interval entry according to the environmental control rule dataset associated to that given time interval entry.

According to example systems and methods disclosed herein, the schedule modifier defines important days associated to one or more of religion, cultural identity, organization, and career status.

According to example systems and methods disclosed herein,

According to example systems and methods disclosed herein, the systems and methods further include receiving a user customization request for customizing a time interval entry of the in-use schedule dataset and modifying the in-use schedule based on the received user customization request.

According to example systems and methods disclosed herein, the customization request defines at least one special day and wherein modifying the in-use schedule comprises changing the type field of the time-interval entry to special.

According to example systems and methods disclosed herein, the systems and methods further include transmitting an alert comprising information regarding an upcoming time interval entry defined by the in-use schedule dataset, the time interval entry defining a real-world time interval and receiving at least one environmental control rule modification request for modifying the environmental control rules for the real-world time interval.

According to example systems and methods disclosed herein, the alert is transmitted on a display of the thermostat system or as an electronic message via at least one of the wide-area communication module and the local communication module and the alert comprises a prompt for a user to input the at least one environmental control rule modification request.

According to example systems and methods disclosed herein, the environmental control rules comprise different control sub-rules associated to different contiguous intervals of a year.

According to example systems and methods disclosed herein, the event entry is an entry made to a schedule stored on the remote device.

According to example systems and methods disclosed herein, the systems and methods further include determining environmental control sub-rules based on the determined event entry and controlling the HVAC interface module according to the environmental control sub-rules during an interval of time defined by the event entry.

According to example systems and methods disclosed herein, the systems and methods further include determining from the event entry a time a user will be away from the external HVAC system and a time a user will be in proximity of the external HVAC system and the environmental control sub-rules are determined based on the time the user will be away and the time the user will be in proximity.

According to example systems and methods disclosed herein, determining the environmental control sub-rules comprises setting an environmental control instruction for a time before the time user will be in proximity.

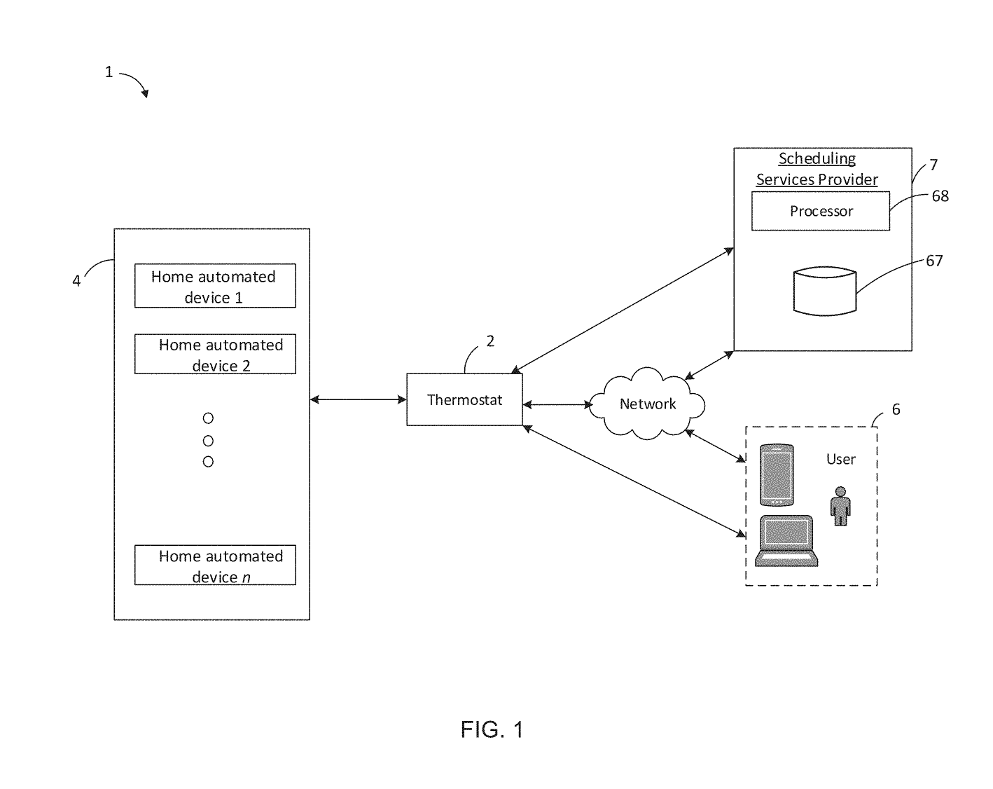

Referring now to FIG. 1, therein illustrated is a block diagram of a thermostat-controlled home automation system 1 according to various exemplary embodiments. The thermostat-controlled home automation system 1 includes a thermostat system 2, a set 4 of home automated devices, at least one remote user device 6, and at least one scheduling services provider 7.

The home automated devices of the set 4 are in communication with the thermostat system 2 to provide information to the thermostat system 2 and/or receive control signals therefrom. The home automated devices communicate with the thermostat system 2 according to various schemes described herein.

The at least one remote device 6 may be located near the thermostat system 2 (e.g. within the same building as the thermostat system 2) or remotely of the thermostat system 2 (e.g. outside the building of the thermostat system 2). The remote device 6 may be in communication with the thermostat system 2 via a local area network. In another example, the remote device 6 may be in communication with the thermostat system 2 via an external wide area network 16, such as the Internet or cell communication network (e.g. GSM, CDMA, LTE, HDSPA, etc.). In yet another example, the remote device 6 may be in direct one-to-one communication with the thermostat system 2 via a known communication protocol, such as Wi-Fi, Bluetooth, or Near Field Communication.

The at least one remote device 6 may be registered with the thermostat system 2 (e.g. either directly or via a server) in that at least one identifier of each of the registered remote devices 6 are known to the thermostat system 2 so as to permit the thermostat system 2 to communicate with the registered remote devices 6. For example, and as illustrated, the at least one remote device 6 includes a smartphone/tablet and a personal computer.

The scheduling services provider 7 includes a processor 68 and a remote storage device 67. The at least one remote device 6 and the thermostat system 2 may be registered together and the registration may be stored at the scheduling services provider 7. The scheduling services provider 7 may further assist in managing scheduling information for the thermostat system 2, including making available schedule datasets and modifier datasets. The scheduling services provider 7 may further provide storage of in-use schedule dataset for the thermostat system 2.

The scheduling services provider 7 is located remotely of the thermostat system 2 and may be in communication with the thermostat system 2 via the wide area network or via a dedicated connection. The wide area network refers to a network where other data traffic may be transported, such as the Internet, cell communication network, or ground line phone network. The dedicated connection refers to a connection used only for communicating with the at least one external services provider.

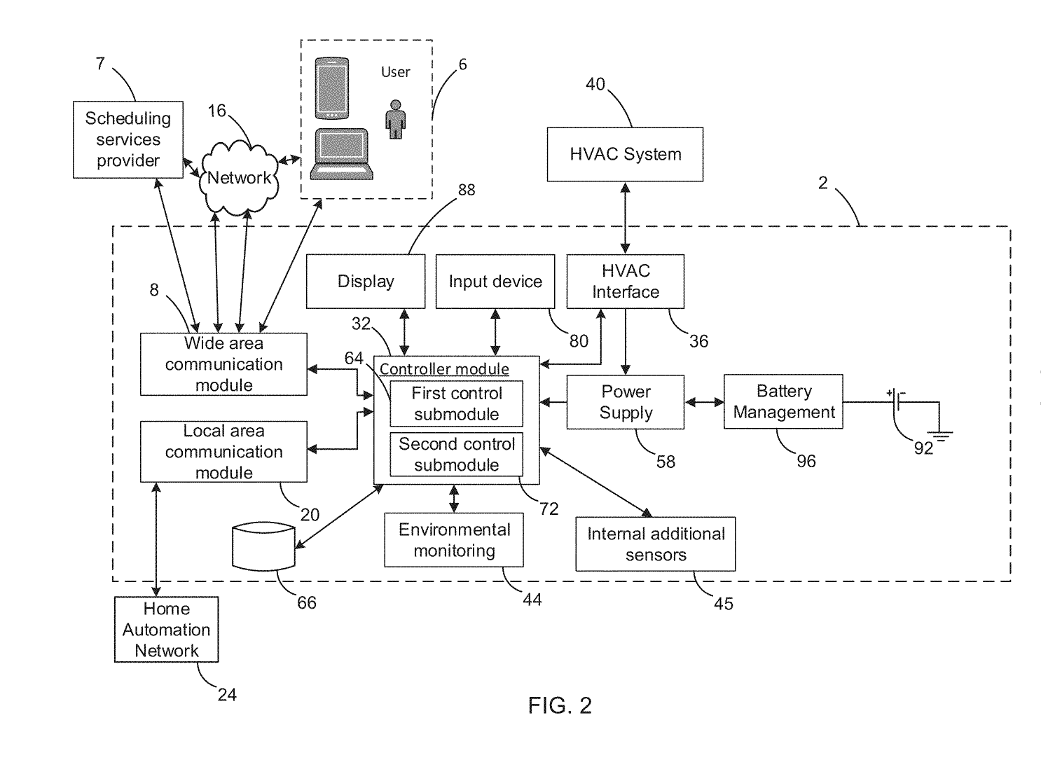

Referring now to FIG. 2, therein illustrated is a schematic diagram of the operational modules of a thermostat system 2 according to various exemplary embodiments. The thermostat system 2 may be used within a home automation system to provide centralized access of connected home automated devices.

The thermostat system 2 includes a wide area communication module 8 configured for data communication with an external wide area network 16, such as the Internet or cell network. For example, the wide-area communication module 8 may be implemented as a network interface controller, which may be an Ethernet or Wi-Fi module. For example, the wide-area communication module includes a Wi-Fi module. The wide-area communication module may also implement communication protocol, in hardware and/or software, for data communication with the external wide area network 16. The communication protocol may provide transport and/or link layer services, such as TCP/IP.

The thermostat system 2 also includes a local communication module 20 configured for data communication within a local home automation network 24. For example, the home automation network can be a local area network implemented using known technology standards such as Ethernet, Wi-Fi, Bluetooth, ZigBee, Z-Wave or mixture thereof. It will be understood that the local home automation network 24 can communicate with another device within the local home automation network 24 in a one-to-one relationship or via a hub or router.

According to various exemplary embodiments, the wide-area communication module 8 and the local communication module 20 may be implemented as a single module. For example, the single module may be in communication with the networked home automated devices via a hub or router, wherein the hub, router or one of the home automated devices provides communication with the external wide area network 16. For example, a suitable router within a local Ethernet and/or Wi-Fi network provides an internet connection while also allowing communication amongst nodes of the local network.

The thermostat system 2 further includes a controller 32 in signal communication with the wide-area communication module 8 and the local area communication module 20. The controller described herein may be implemented in hardware or software, or a combination of hardware and software. It may be implemented on a programmable processing device, such as a microprocessor or microcontroller, Central Processing Unit (CPU), Digital Signal Processor (DSP), Field Programmable Gate Array (FPGA), general purpose processor, and the like. In some embodiments, the programmable processing device can be coupled to program memory, which stores instructions used to program the programmable processing device to execute the controller. The program memory can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, and optical media.

The controller 32 is operable to transmit data to and receive data from the wide-area network 16 via the wide area communication module 8. The controller 32 is also operable to transmit data to and receive data from the home automation network 24 via the local area communication module 20.

According to various exemplary embodiments, the thermostat system 2 may also include a HVAC interface module 36. The output side of HVAC interface module 36 may be connected to a HVAC system 40. The HVAC interface module 36 may be further operable to control the HVAC system 40. For example, the HVAC interface module 36 may include mechanical, electrical and/or electronic components for making a heating call or cooling call to the HVAC system 40. For example, the HVAC interface module 36 may output HVAC control signals for controlling the HVAC system 40. For example, connection of the HVAC interface module 36 with the HVAC system 40 may be carried out according to known connections, such as using C, R, Rh, Rc, G, W, Y wires. Other connections may be used for more complex HVAC systems, such as heat pumps and multi-stage HVAC systems. For example, the HVAC interface module 36 can further control the HVAC system to provide humidifying and dehumidifying.

According to one exemplary embodiment, the HVAC interface module 36 may be integrated with other components of the thermostat system 2, such as the controller 32. The HVAC interface module 36, controller 32, wide area communication module 8 and local area communication module 20 may be implemented within an embedded system or as part of a system-on-chip.

According to other exemplary embodiments, the HVAC interface module 36 may be external to the thermostat system 2 and may be in communication with the controller 32 via the local area communication module 20 or via a data port of the thermostat system 2.

The thermostat system 2 may further include at least one environmental monitoring module 44 for sensing at least one condition of the environment surrounding the thermostat system 2. The environmental monitoring module 44 includes at least one physical sensor for sensing the at least one environmental condition. For example, the at least one physical sensor includes a temperature sensor for determining temperature of the environment surrounding the thermostat system 44. The at least one environmental monitoring module 44 is coupled to the controller 32 and the condition sensed by the environmental monitoring module. According to various exemplary embodiments, the thermostat system 2 includes a plurality of environmental monitoring modules 44 for sensing one or more of temperature, humidity level, concentration levels of CO, CO₂, smoke, formaldehyde, natural gas, volatile organic compounds (VoC), and dust/particles level.

According to other exemplary embodiments, the thermostat system 2 may further include at least one internal additional sensor 45. The internal additional sensor 45 is described as “internal” in that it is physically located within the form factor of the thermostat system 2. For example, the internal additional sensor 45 may be embedded within (e.g. sharing circuity with) the thermostat system 2. The internal additional sensor 45 may sense a condition other than an environmental condition. For example, the additional internal sensor 45 may include an occupancy/motion sensor (hereinafter occupancy sensor), water flooding sensor, anemometer, vibration sensor (e.g. to detect vibration, shock, and or seismic waves), and fingerprint reader.

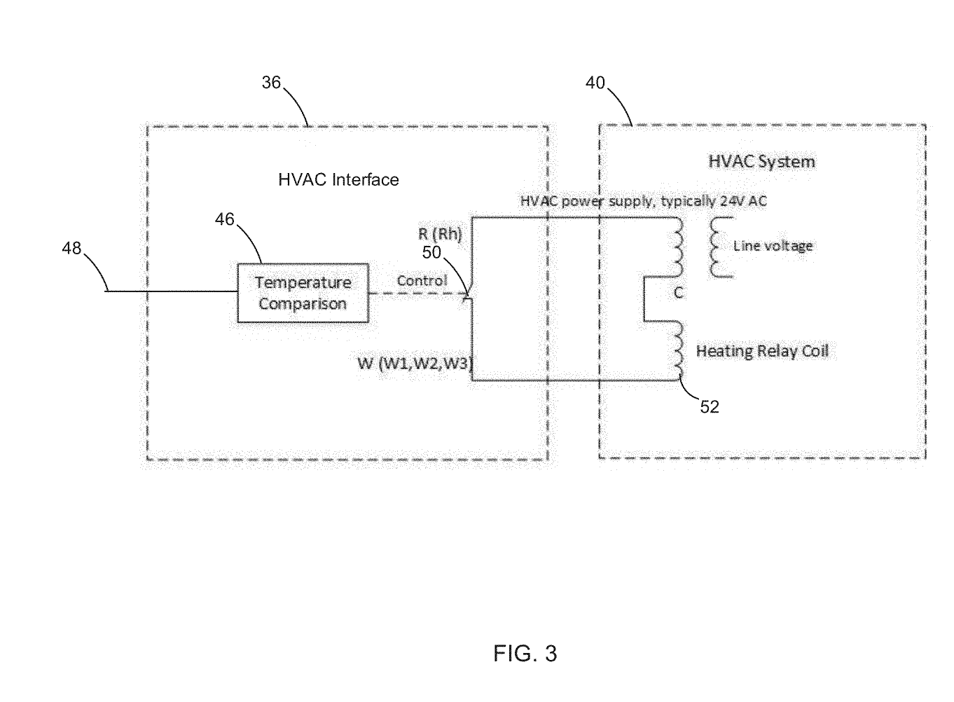

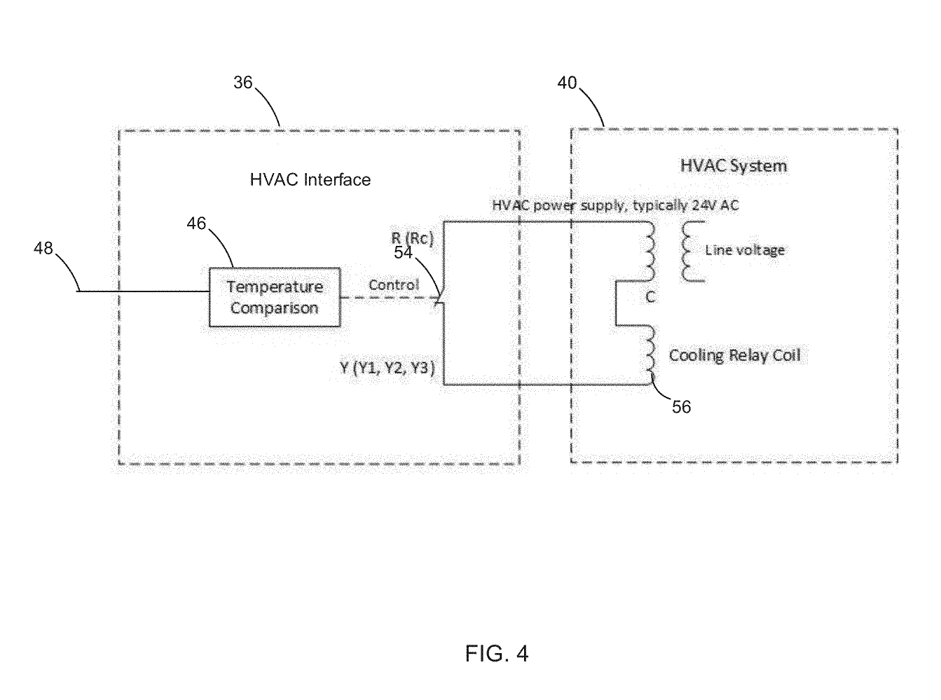

Referring now to FIGS. 3 and 4, therein illustrated are schematic circuit diagrams of operative connections between a HVAC interface module 36 with a HVAC system 40 during a heating call and a cooling call respectively. The HVAC interface module 36 includes a temperature comparator 46 having at least one input 48 for receiving a control signal indicating a desired temperature setpoint and a current temperature. For example, the current temperature may be sensed by the environmental monitoring module 44 (FIG. 2). The temperature comparator 46 compares the sensed current temperature with the temperature setpoint and outputs a control signal to the HVAC system 40. As illustrated in FIG. 3 the temperature comparator 46 can output a signal to drive a heating call relay 50, which causes current to flow through the heating relay coil 52 of the HVAC system 40, thereby causing the HVAC system 40 to begin heating. As illustrated in FIG. 4 the temperature comparator 46 can output a signal to drive a cooling call relay 54, which causes current to flow through the cooling relay coil 56 of the HVAC system 40, thereby causing the HVAC system 40 to begin cooling. Other calls may be possible for more complex HVAC systems. Controlling the HVAC system 40 to operate different leads to a change in environmental conditions within the building.

Referring back to FIG. 2 the thermostat system 2 further includes a power supply 58 for providing electrical power to various components of the thermostat system 2, such as the wide-area communication module 8, the local area communication module 20 and the controller 32. According to one exemplary embodiment, the power supply 58 may draw alternating current (AC) power from a typical 110V-220V AC mains electricity supply. According to another exemplary embodiment, the power supply 58 draws electric power from the HVAC system 40, which may typically be 24V AC.

According to various exemplary embodiments wherein the thermostat system includes an internal HVAC interface, the controller 32 includes a first control submodule 64 configured to access the HVAC interface module 36. The first control submodule 64 can generate one or more control signals for accessing the HVAC system 40 via the HVAC interface 36. For example, the first control submodule 64 can generate a control signal to change the temperature setpoint for the HVAC system 40. For example, the first control submodule 64 can also generate a control signal to change the humidity setpoint for the HVAC system 40.

According to various exemplary embodiments, the first control submodule 64 in combination with the HVAC interface module 36 can receive data information pertaining to an environmental condition, such as temperature and/or humidity level and control the HVAC system based on the received information. The environmental condition may be received from the environmental monitoring module 44. The control may be performed exclusively by the first control submodule 64, exclusively by the HVAC interface module 36 or a combination of both the first control submodule 64 and the HVAC interface module 36. For example, the first control submodule 64 may send control signals to the HVAC interface module 36 to set a temperature setpoint and/or humidity setpoint. This temperature setpoint and/or humidity setpoint may be selected based on a user-inputted command or a preprogrammed schedule. The HVAC interface 36 can further control various relays of the HVAC system 40 for heating, cooling, humidifying or dehumidifying based on the received temperature set point and/or humidity setpoint.

In some further examples, the first control submodule 64 and/or the HVAC interface module 36 can monitor indoor air quality, such as concentration levels of CO, CO₂, smoke, formaldehyde, natural gas, VoC and dust/particles level and appropriately control the HVAC system 40 to improve the air quality. For example, the environmental monitoring module 44 can monitor such environmental conditions.

Data information pertaining to one or more environmental conditions may be received from the internal environmental monitoring module 44 of the thermostat system (if provided). Alternatively, data information pertaining to one or more environmental conditions may be received from environmental monitoring devices directly connected to the thermostat system 2 and/or network-connected to the thermostat system 2, as described hereinbelow.

The thermostat system 2 may further include a local storage device 66 coupled to the controller 32. The local storage device 66 can include non-transitory storage media, both volatile and non-volatile, including but not limited to, flash memory, magnetic media, and optical media.

In other embodiments, a storage device 67 may be provided remotely, such as a cloud-based storage device 67. The controller 32 may receive data from the remote storage device 67 via the wide-area communication module 8 or the local-area communication module 20.

Schedule datasets may be stored on the local storage device 66 and/or on the remote storage device 67. The schedule datasets may be used for automatically controlling the HVAC interface module 36 to further control environmental conditions of the building over various intervals of time.

One or more environmental control rules datasets may also be stored on the local storage device 66 and/or on the remote storage device 67. Automatic control of the HVAC interface module 36 and the environmental conditions of the building may also be based on the environmental control rules datasets.

The controller 32 includes a second control submodule 72 configured to access home automated devices that are network connected to the thermostat system 2. The second control submodule 72 can also generate one or more control signals for controlling one or more network connected home automated devices that are operable to be controlled. The control signals generated for each controllable network connected home automated device may depend on the type of that home automated device.

According to various exemplary embodiments, as a given home automated device is connected to the thermostat system 2 via the home automation network 24, the second control submodule 72 can be programmed so as to become configured to generate control signals that correspond to the properties of the given home automated device 1. For example, where the given home automated device is a dimmable light, the second control submodule 72 can be programmed with a light control submodule for controlling the light to different brightness levels.

According to various exemplary embodiments, the thermostat system 2 includes an input device 80 and a display 88. For example, the input device 80 can be a keypad, mouse, voice recognition, stylus, and/or a touchscreen. In the case of a touchscreen, the input device 80 is integrated with the display 88. The input device 80 can be manipulated by a human user to enter commands. Commands inputted by the user can be received at the controller 32.

According to various exemplary embodiments wherein the thermostat system includes an internal HVAC interface 36, where the command is for controlling the HVAC system 40, the first control submodule 64 can generate a control signal based on the received command. In particular, the command can be for changing an environmental setting (ex: desired temperature and/or humidity) and the first control submodule 64 can at least generate a control signal based on the received command for controlling the HVAC system 40 via the HVAC interface 32.

Where the command is for controlling a network connected home automaton device, the second control module 72 can generate a control signal based on the received command and further based on the programming of the second control module 72 storing properties of the given network connected home automated device. The generated control signal can then be transmitted via the local communication module 20 and over the home automation network 24 to control the given home automated device. For example, the command can be for changing a non-environmental setting.

Where the second control submodule 72 is programmed based on a given home automated device being added to the home automation network 24 and being connected to the thermostat system 2, the second control submodule 72 can be further programmed to display on the display 88 a user interface having various elements that can be manipulated by a user, such as buttons, sliders, etc. The elements displayed may be specific to properties of the given home automaton device so that a user can easily provide control commands specific to the home automated device. For example, programming the second control submodule 72 may be installing software or adding an “app” specific to the given home automated device.

The control module 32 can further receive over the wide-area network 16, such as the internet, one or more commands for accessing one or more of the home automated devices. The one or more commands are received via the wide-area communication module 8. The commands may be inputted using a user-operable device connected to the wide-area network, such as computer or mobile device (ex: tablet, smartphone). The user-operable device may be one of the registered remote devices 6. The command may also be generated from a predetermined control scheme stored on a device connected to the wide-area network. For example, the control scheme can be predefined by a user, such as via a web portal, and saved to a server. The server can then send the commands over the wide-area network 16 to the communication module 8.

According to various exemplary embodiments wherein the thermostat system includes an internal HVAC interface 36, where the command received over the wide-area network is for controlling the HVAC system 40, the first control submodule 64 can generate a control signal based on the received command.

Where the command received over the wide-area network 16 is for accessing a network connected home automated device, the second control submodule 72 can generate a control signal based on the received command. It will be appreciated that the thermostat system 2 having the wide-area communication module and the local area communication module act as a network gateway between the wide-area network 16 and a network connected automation device. That is, the thermostat system 2 provides a bridge between the wide-area network 16 and the home automation network 24. More particularly, the thermostat system 2 is operable to translate network protocols of the wide-area network 16 to network protocols of the home automation network 24, and vice versa.

It will be appreciated that according to various exemplary embodiments wherein the thermostat system includes an internal HVAC interface 36, the HVAC system 40 is connected to the thermostat system 2 while bypassing the home automation network connection 24. Therefore, the HVAC system 40 can be controlled independently of the home automation network 24. That is, the HVAC system can be controlled without using the home automaton network 24.

In the example of FIG. 2, the HVAC interface 36 is included within the thermostat system 2. Control signals generated by the first control submodule 64 follow a signal path to the HVAC system 40 via the HVAC interface 36 while bypassing the home automation network connection 24. Therefore, it is possible to operate the thermostat system 2 to control the HVAC system 40 without requiring a home automation network 24 or a wide-area network connection 16. Alternatively, the wide-area network connection 16 can be used to receive commands from a remote device over the wide area network 16 to control the HVAC system 40 or send data to the remote device over the wide area network 16, while still not requiring a home automation network 24. However, the availability of the local communication module 20 and the second control module 72 allows the thermostat system 2 to be scalable. More particularly, the thermostat system 2 is scalable in that access of additional home automated devices with the thermostat system 2 can be provided by making use of the second control submodule 72, the local area communication module 20 and the home automation network 24. The additional home automated devices may be added as network connected home automated devices to provide scalability.

Continuing with FIG. 2, according to various exemplary embodiments, the thermostat system 2 may further include a battery 92 and a battery management module 96. According to some exemplary embodiments, the battery management module 96 can be configured to cause the battery 92 to provide electric power to components of the thermostat system 2 when there is a power outage, or boost current supply when the power from the HVAC system 40 is limited.

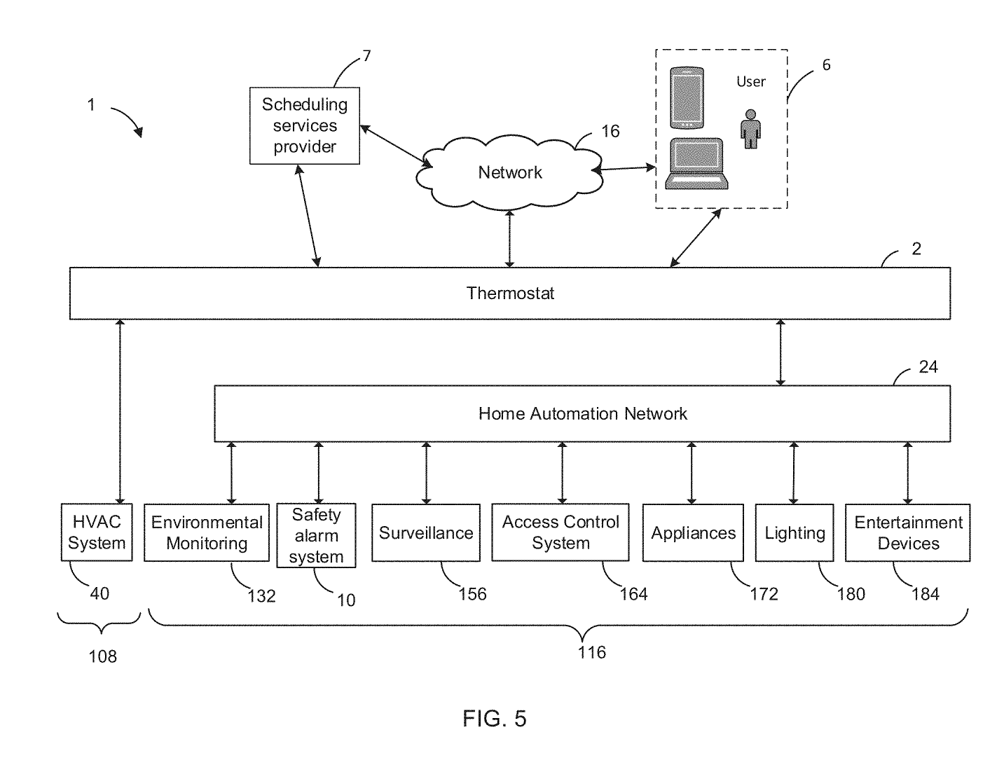

Referring now to FIG. 5, therein illustrated is a schematic diagram of a home automation system 1 according to one exemplary configuration. The system 1 includes a thermostat system 2 providing centralized access to a plurality of home automated devices.

The thermostat system 2 is operable to communicate with home automated devices according to a two-tier scheme. The two tier scheme herein refers to the thermostat system 2 being differently coupled to the plurality of home automated devices so as to communicate with home automated devices in at least two different ways.

In the first tier, at least one home automated device 116 forming a first subset of the plurality of home automated devices 108 is directly connected to the thermostat system 2. For example, the directly connected home automated device 108 is connected to the thermostat system 2 in a star data communication relationship. For example, the at least one directly connected home automated device is in data communication with the thermostat system 2 while bypassing the home automaton network 24. Since the thermostat system 2 includes an internal HVAC interface 36 allowing the thermostat system 2 to be directly connected to the HVAC system 40, the HVAC system 40 may belong to first subset of home automated devices 108. For example, and as illustrated, the first subset of directly connected home automated devices includes only the HVAC system 40.

In the second tier, at least another one home automated device may form a second subset of the plurality of home automated devices and may be connected to the thermostat system 2 via the home automation network 24. The home automated devices belonging to the second subset are each a network connected home automated device 116. The second control module 72 of the thermostat system 2 is operable to generate control signals, which are transmitted over the home automation network 24 to one or more of the network connected automated home devices 116 of the second subset. The one or more network connected automated home devices 116 receiving the control signals are then controlled accordingly. For example, the control signals control the one or more network connected home automated devices according to a home automation network protocol. The home automation network protocol may be a known or standard protocol, such as X10, ZigBee, Z-Wave, Bluetooth. For example, and as illustrated, the networked home automated devices connected to the home automation network 24 may include at least one external environmental monitoring device 132, the safety alarm system 10, a surveillance system 156, an access control system 164, at least one appliance 172, at least one lighting device 180 and at least one entertainment device 184.

The external environmental monitoring device 132 may include one or more sensors for sensing one or more conditions. The plurality sensors may be provided in one device, or a plurality of devices. The sensed conditions may include temperature, humidity level, concentration levels of CO, CO₂, smoke, formaldehyde, natural gas, VoC, dust/particles level, UV light level (ex: UVA or UVB), water inundation, earthquake detection, etc.

It will be appreciated that the at least one home automated device 108 belonging to the first subset of devices can be in signal communication with the thermostat system 2 independently of the home automation network 24. That is, the directly connected home automated device can be accessed by the thermostat system 2 independently of the operation of the home automation network 24. For example, in some cases, the thermostat system 2 can be operable to control the at least one devices of the first subset of devices even where a home automation network 24 is not provided. That is, the home automated devices may all belong to the first subset and the second subset does not have any members.

Continuing with FIG. 5, the thermostat system 2 is further operative to transmit and receive data over a wide area network 16, such as the Internet. It will be appreciated that the thermostat system 2 acts as a gateway for the network connected home automated devices 116 to the wide area network 16.

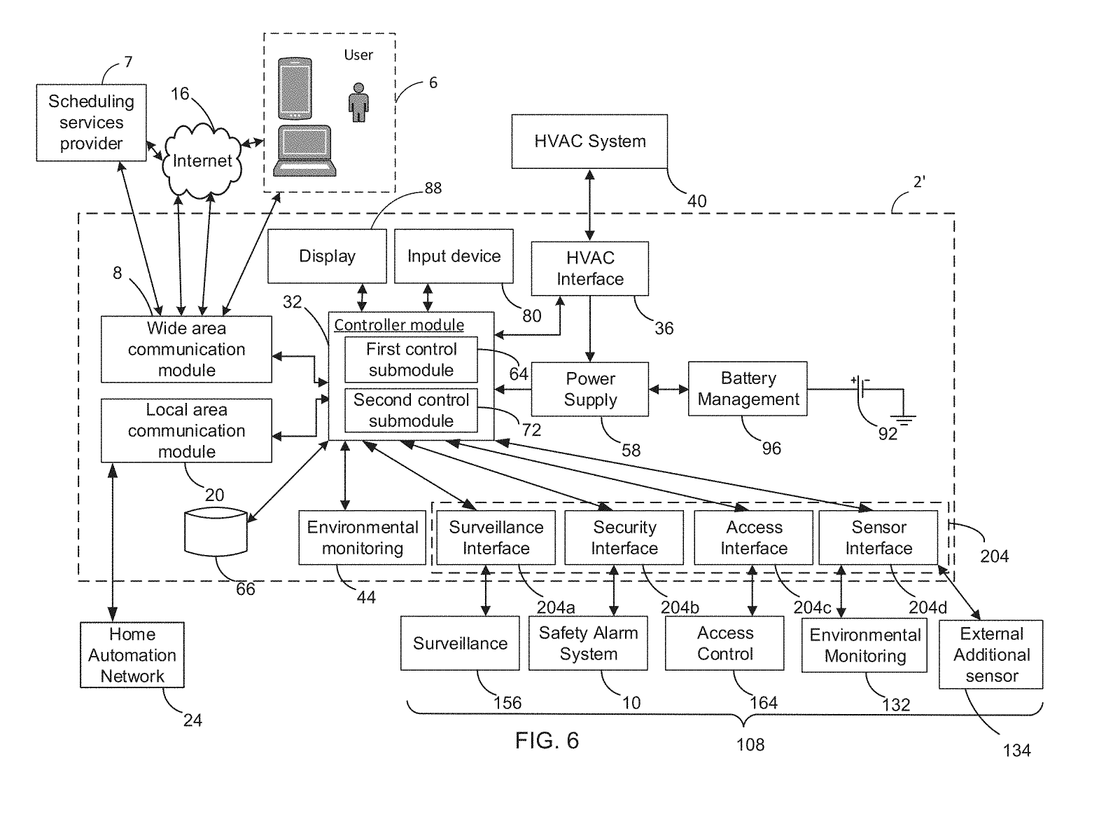

Referring now to FIG. 6, therein illustrated is a schematic diagram of a thermostat system 2′ according to an exemplary variant of the thermostat system 2 illustrated in FIG. 2. The thermostat system 2 of FIG. 6 is similar to that of FIG. 2 but further includes at least one additional device interface 204 that is coupled to the control module 32. The device interface 204 can be directly connected to one or more home automated devices. For example, each device interface 204 is directly connected to one home automated device. For example, at least one of the device interfaces 204 may be preconfigured according to a type of home automated device to be connected to that interface. For example, the device interface 204 may have an interface board implemented in hardware, which may be updated via firmware.

The at least one additional device interface 204 is in data communication with the controller 32. Accordingly, the controller 32 may be operable to generate a control signal, which can be transmitted to at least one of the directly connected home automated devices via the at least one additional device interface 204. Similarly, the controller 32 may be operable to receive data from at least one of the directly connected home automated devices via the at least one additional device interface 204. The received data may provide information about a status or condition of a home automated device connected via a device interface 204.

The at least one additional device interface 204 may be connected to typical devices that will be included in the home. For example, these typical devices may be ones that are centrally connected within the building. Such devices may include a surveillance system, an alarm system, a building access system, and various environmental sensors (ex: thermometer, barometer, humidity level detector). As illustrated, the exemplary thermostat system 2′ includes a surveillance interface 204a for accessing the surveillance system 156, a security interface 204b for accessing a the safety alarm system 10, an access interface 204c for accessing a building access control system 164 and a sensor interface 204d for accessing one or more external monitoring devices 132. For example, the external monitoring devices 132 provide sensing of environmental conditions other than those sensed by the internal environmental monitoring system. Alternatively, or additionally, the external monitoring devices 132 can monitor conditions at locations remote of thermostat system 2, such as another room of the building or outside the building (i.e. multi-zone sensing/monitoring).

The sensor interface 204d may also access at least one directly connected home automated device that is an external additional sensor 134. The external additional sensor 134 is described as “external” in that is not physically located within the form factor the thermostat system 2 while maintaining communication with the thermostat system 2′. For example, and as illustrated in FIG. 6, the external additional sensor 134 includes directly connected external additional sensor 134. However, it will be understood that the external additional sensor 134 may also be a network connected home automation device. In some exemplary embodiments, the external additional sensor 134 may include at least one directly connected external additional sensor and at least one network-connected external additional sensor. For example, the external additional sensor 134 may be include an occupancy sensor, water flooding sensor, anemometer, vibration sensor (e.g. to detect vibration, shock, and or seismic waves), and fingerprint reader.

According to one exemplary embodiment, the first control submodule 64 may be further operable to access (control and receive information) for one or more of the directly connected home automated devices in communication with the controller 32 via one or more of the device interfaces 204. For example, the first control submodule 64 may be preprogrammed according to home automated devices that are expected to be directly connected to the thermostat system 2′.

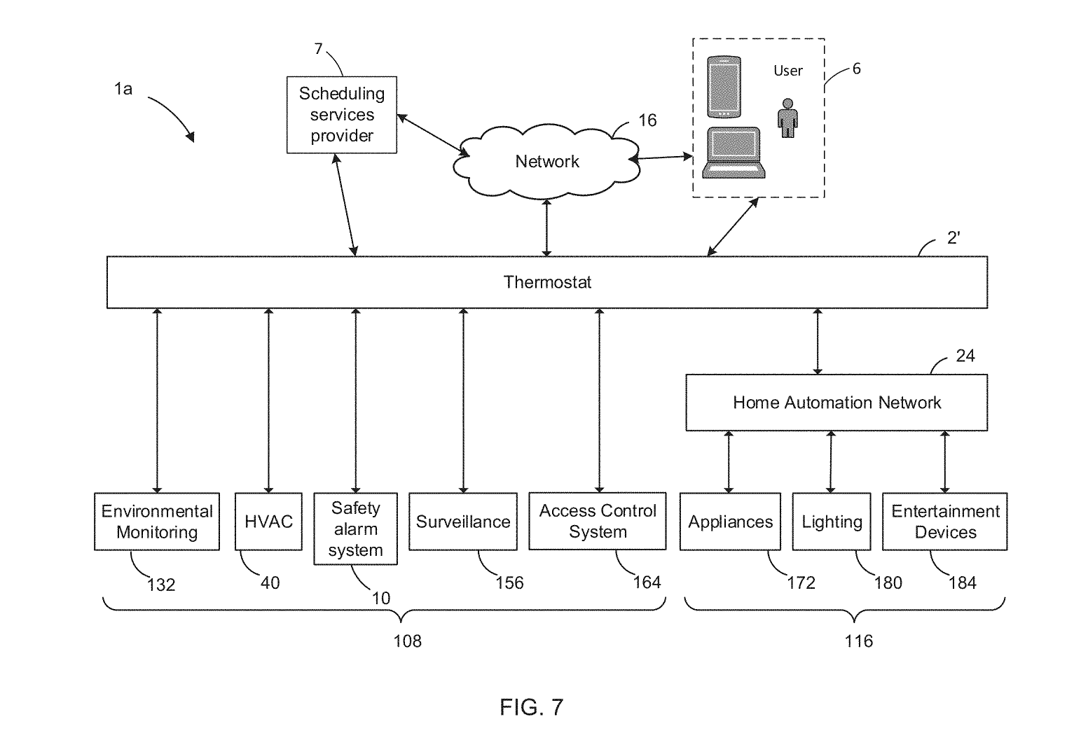

Referring now to FIG. 7, therein illustrated is a schematic diagram of a home automation system 1a according to another exemplary configuration. As illustrated, the home automation system 1a includes the thermostat system 2′ having at least one addition device interface 204 as described herein with reference to FIG. 5. It will be appreciated that in the home automation system 1a, the first subset of home automated devices 108 being directly connected to the thermostat system 2′ has more than one member.

As illustrated, and consistent with FIG. 6, the first subset of home automated devices 108 being directly connected to the thermostat system 2′ includes the external environmental monitoring device 132, the HVAC system 40, the security system 10, the surveillance system 156 and the access control system 164. Being directly connected with the thermostat system 2′, each of the directly connected home automated devices 108 may be accessed by the thermostat system 2′ independently of the home automation network 24. That is, the thermostat system 2′ is in communication with each of the directly connected home automated devices 108 while bypassing the home automation network 24.

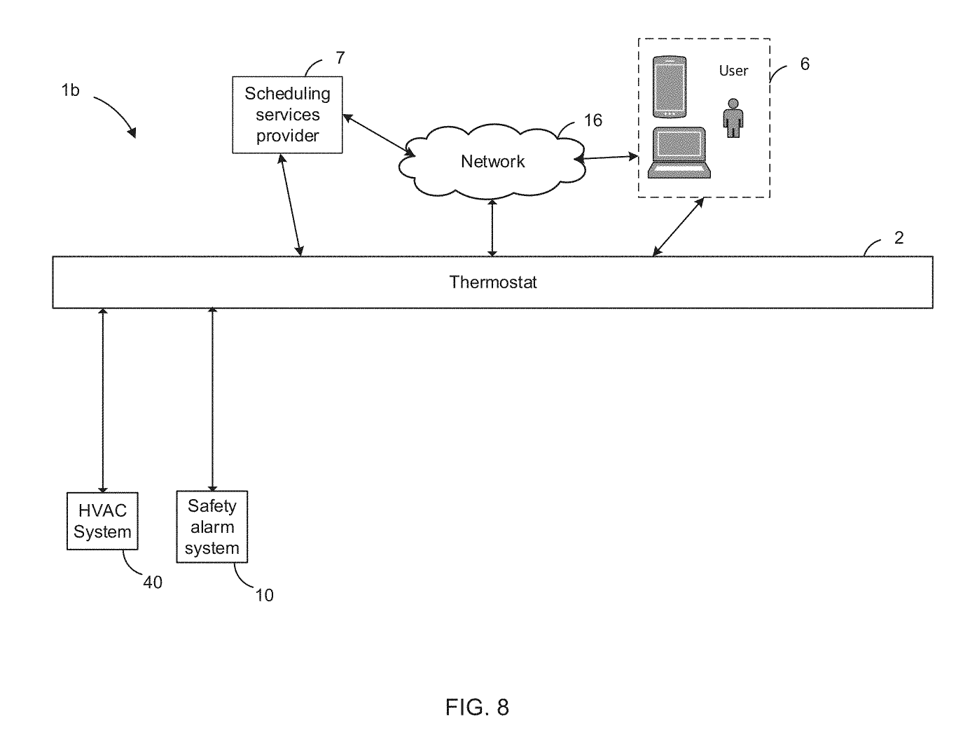

Referring now to FIG. 8, therein illustrated is a schematic diagram of a home automation system 1b according to yet another exemplary configuration. The home automation system 1b may include either one of the thermostat system 2 described herein with reference to FIG. 2 or the variant thermostat system 2′ described herein with reference to FIG. 6. As illustrated, only the HVAC system 40 and the safety alarm system 10 are provided within the home automation system 1b. It will be appreciated that the providing of the internal HVAC interface 36 within the thermostat system 2 allows it to be used in a way that resembles a traditional thermostat. For example, where a connection to the wide area network is not provided, a user can input commands or provide a preprogrammed HVAC control schedule using the user input device 80 of the thermostat, and the thermostat system 2 can be operable to control the HVAC system 40 according to the inputted command or preprogrammed system. For example, where a connection to the wide-area network 16 is provided, commands or HVAC control schedule may be inputted by the user using a suitable device via the wide-area network 16. Information pertaining to the HVAC system 40 may be further received by the user device over the wide-area network 16. As illustrated in FIG. 8, the example home automation system 1b further includes a safety alarm system 10 being a directly-connected home automation device.

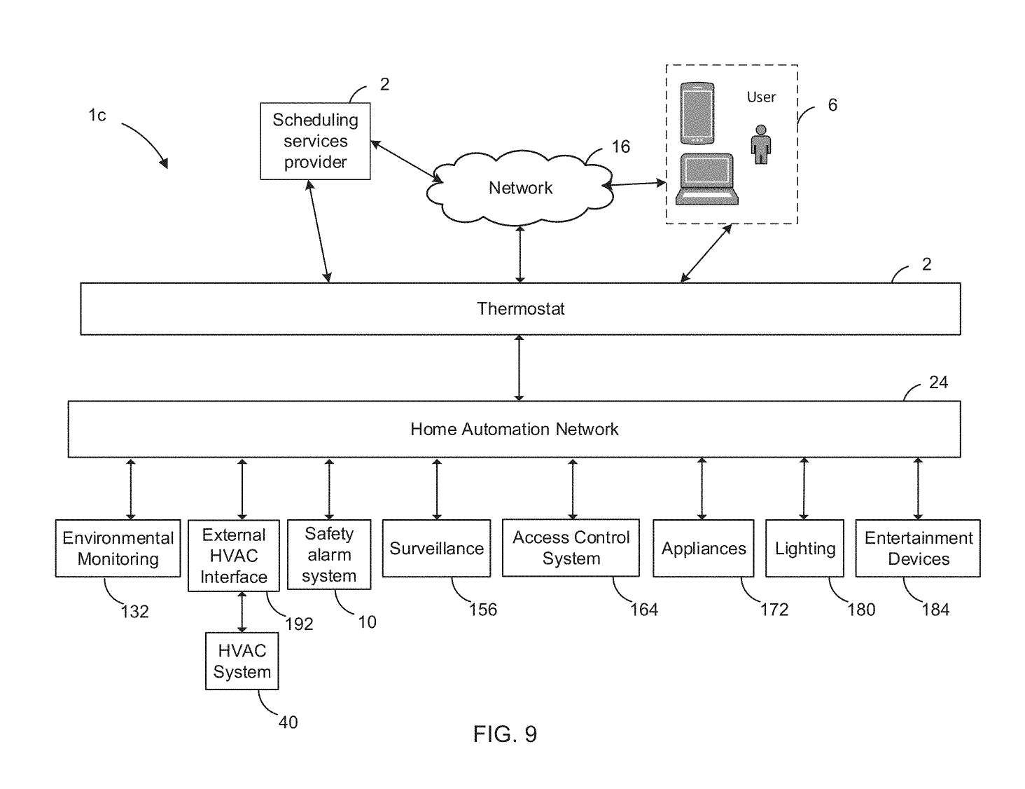

Referring now to FIG. 9, therein illustrated is a schematic diagram of a home automation system 1c according to yet another exemplary configuration. According to this exemplary configuration, each of the home automated devices of the home automation system 1c is a network connected home automated device 116 that communicates with the thermostat system 2 or variant thermostat system 2′ via the home automation network 24. An external HVAC interface 192 is provided to generate signals for the HVAC system 40. That is, the external HVAC interface 192 is hardwired to the HVAC system 40, while being accessed by the thermostat system 2 via the home automation network 24. For example, this configuration may be used where the thermostat system 2, 2′ is being provided within an already existing home automation network 24 that included an external HVAC interface 192.

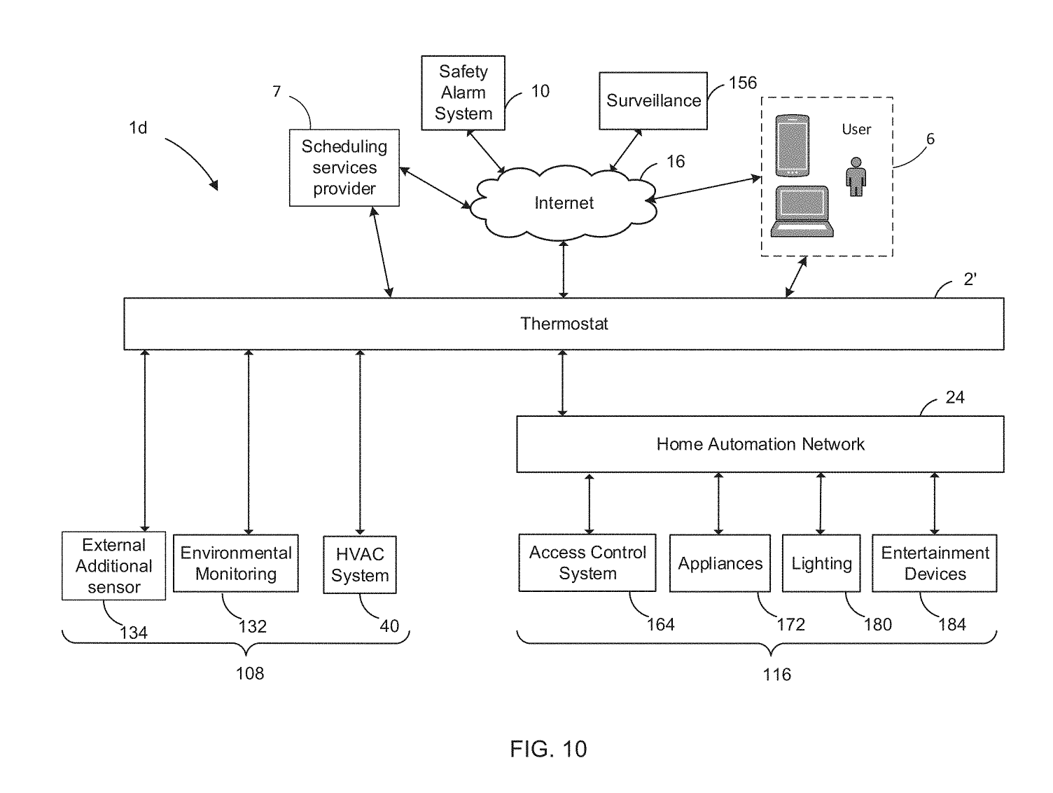

Referring now to FIG. 10, therein illustrated is a schematic diagram of a home automation system 1d according to yet another exemplary configuration. According to this exemplary configuration, the home automated devices are in communication with the thermostat system according to a three-tier scheme. While the variant thermostat system 2′ is illustrated, it will be understood that the thermostat system described with reference to FIG. 2 may also be used within the three-tier scheme.

As illustrated, the first subset of the home automated devices includes the external environmental monitoring device 132, the external additional sensor 134 and the HVAC system 40. These home automated devices are directly connected home automated devices 108 and represent the first tier of communication with the thermostat system.

The second subset of the home automated devices includes the access control system 164, appliances 172, lighting device 180 and entertainment 184. These home automated devices are networked connected home automated devices 116 that communicate with the thermostat system 2′ via the home automation network 24 and represent the second tier of communication with the thermostat system.

The third subset of the home automated devices include at least one device that communicate with the thermostat system via the wide area network 16 and represent the third tier of communication with the thermostat system. For example, the at least one home automated device of the third subset is not operable to communication over a home automation network 24 (ex: does not have appropriate network protocol). Alternatively, the at least one home automated device of the third subset is located at a distance from the thermostat system 2′ that is greater than the maximum operational range of the network protocol of the home automation network. However, the thermostat system may still access the at least one home automated device of the third subset via the wide-area network 16. As illustrated, and for example purposes, the safety alarm system 10 and the surveillance system 156 are connected to the thermostat system via the internet 16. For example, the thermostat system 2′ can receive a status of the security system, which can be further displayed on the display 88 of the thermostat system 2. For example, a video stream of video captured by the surveillance system 156 may be displayed on the display 88 of the thermostat system 2′.

In many cases, users are primarily concerned with a higher level of automated control of the HVAC system while being less interested in automation of other devices within the house. Accordingly, these users may be interested in acquiring an automated thermostat system without having to acquire a full featured home automation system. Advantageously, according to various exemplary embodiments wherein the thermostat system includes an internal HVAC interface 36, the thermostat system 2, or 2′ described herein according to various exemplary embodiments is ready to use as a thermostat for controlling the HVAC system.

However, such users may at a later stage be interested to progressively add more automation of other devices within the building. Advantageously, the local area communication module 20 and the second control module 72 of the thermostat system 2 or 2′ described herein according to various exemplary embodiments may be used to provide automated control of additional home automated devices 116 via a home automation network 24.

It will be appreciated that various exemplary thermostat systems described herein allow for flexible configuration of a home automation system. Furthermore, the thermostat system is configured to access home automated devices in at least two ways. Moreover, the thermostat system is configured to make available to a user information pertaining to the home automated devices in various ways.

For example, environmental conditions surrounding the thermostat system can be sensed using the internal environment monitoring module 44. According to some embodiments, environmental conditions can also be sensed using a directly connected environment monitoring module 132. According to yet other embodiments, environmental conditions can be sensed using a network connected external monitoring module 132. In each case, the information may be displayed on the display 88 of the thermostat system 2 and/or transmitted to a remote user device via the wide area communication module 8.

For example, various exemplary embodiments wherein the thermostat system includes an internal HVAC interface 36 are configured to be hardwired to a HVAC system 40. As described, the HVAC system 40 can be accessed independently of a home automation network according to some exemplary embodiments described herein. The thermostat system is also configured to control HVAC system 40 by accessing an external HVAC interface 192 via the home automation network 24. In each case, commands for controlling the HVAC system may be inputted using the user input device 80 of the thermostat system and/or transmitted from a remote user devices to the thermostat system via the wide-area network 16.

For example, and as described, various exemplary thermostat systems are configured to access one or more home automated devices that pertain to non-environmental conditions. As described herein, these home automated devices may be accessed according to a three-tier access. In the first tier, one or more home automated devices may be directly connected to the thermostat system to be controlled by and/or provide information to the thermostat system. In the second tier, one or more home automated devices may be networked connected to the thermostat system to be controlled by and/or provide information to the thermostat system. In the third tier, one or more home automated devices may be connected to the thermostat system to be controlled by and/or provide information to the thermostat system via the wide-area network 16. In each case, information pertaining to one or more non-environmental home automated devices may be displayed on the display 88 of the thermostat system 2 and/or transmitted to a remote user device via the wide area communication module 8. Similarly commands for controlling one or more non-environmental home automated devices may be inputted by a user using the user input device 80 and/or transmitted from a remote user device to the thermostat system via the wide-area network 16.

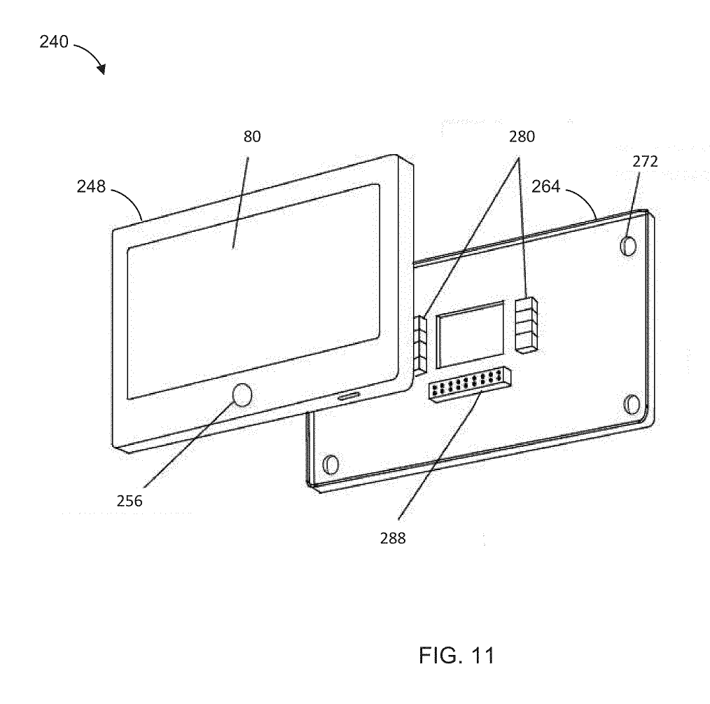

Referring now to FIG. 11, therein illustrated is a perspective view of a packaged thermostat system 2 having been packaged within an enclosure 240 according to various exemplary embodiments. For example, and as illustrated, the enclosure 240 has a form factor that is similar to the form factor of a traditional thermostat. The enclosure 240 includes a face plate 248 having the display 80, which may be a touchscreen providing the user input device 88. The face plate 248 may further include an occupancy sensor for detecting the presence of a human user. For example, various operations of the thermostat system 2 may be controlled based on whether the presence of the human user is detected.

The enclosure 240 further includes a back panel 264. The back panel 264 includes mounts 272 for receiving fasteners for mounting the back panel 264 onto a vertical surface, such as the surface of the wall. Accordingly, the enclosure 240 may be mounted onto a vertical wall like a traditional thermostat. The back panel 264 further includes one or more HVAC wire connectors 280, which provide the physical connection of the wires of the HVAC system 40 with the ports of the HVAC interface 36.

The back panel 264 further includes a board-to-board connector 288 for electronically connecting hardware components provided on the back panel 264 with the hardware components provided on the front panel 256. For example, the hardware components on which the thermostat system 2 is implemented may be provided on the front panel 256, on the back panel 264 or dispersed amongst the front panel 256 and the back panel 264. The board-to-board connector 288 provides communication between the components on the front panel 240 and the back panel 264 as well as power.

According to various exemplary embodiments, the controller 32 of the thermostat system 2 or thermostat system 2′ is operable to automatically control the HVAC interface module 36 to change environmental conditions within the building according to a programmed schedule. For example, the controller 32 can adjust the setpoints (ex: temperature and/or humidity) of the HVAC interface module 36 at various time intervals. The following description is provided for thermostat system 2, but it will be understood that such description is equally applicable to the thermostat system 2′.

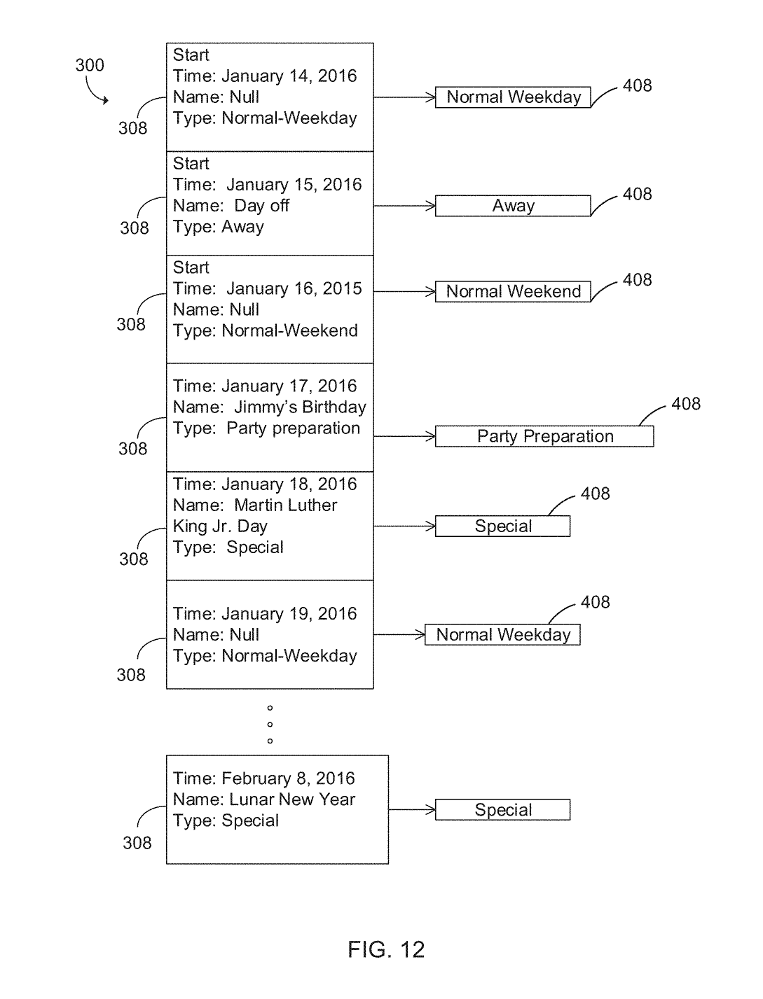

Referring now to FIG. 12, therein illustrated is a schematic diagram of an exemplary data structure 300 of a stored schedule dataset. The schedule dataset provides information about a continuous interval of real-world time having been divided into time intervals. For example, in a data structure 300 for representing a schedule dataset, real-world time intervals may be represented by a plurality of stored time interval entries 308. The time intervals entries 308 represent real-world time intervals, such as seconds, minutes, hours, days, weeks, months and/or years.

Each time interval entry 308 includes information about the real-world time interval. For example, and as illustrated in FIG. 12, each time entry 308 further includes fields denoting time, name and type. The time fields may include a start time and an end time to denote the real-world time interval being represented. Alternatively, the time fields may include a time identifier that defines a start and end, such as a date (i.e. year, month, and day of month). For example, a first time interval entry 308 includes the time field Jan. 14, 2016 to denote that the time interval corresponds to the real-world date of Jan. 14, 2016.

The type field of a time interval entry denotes the type of real-world time interval. The type may represent particular habits and/or lifestyles that are adopted during that real-world time interval. For example, during the weekdays (type: normal-weekday), a user may go to school and work, thereby leaving the building and returning to the building at particular times. By contrast, during the weekends (type: normal-weekend), a user may have different waking, eating, sleeping schedules and different times for leaving and returning to the building. The type of time interval may be used to appropriately select environmental control rules, as described elsewhere herein.

According to various exemplary embodiments, the schedule dataset 300 may have a calendar form. That is, each time interval entry 308 represents a real-world day. Accordingly, the time field may indicate the date (ex: Month, day, year and day of week), the type field may indicate the schedule type of day (ex: weekday, weekend, holiday, etc.) and the name field may indicate a descriptor of the day (ex: name of holiday, etc.). The descriptor may vary based on the applicable country, culture, and/or religion. In other cases, the descriptor may be a customized entry, such as a birthday.

At least one schedule dataset 300 may be set as the in-use schedule dataset when stored, such as in the local storage device 66 and/or the remote storage device 67. For example, a plurality of schedule datasets 300 may be stored, but not in use. The controller 32 follows the in-use schedule dataset for controlling the HVAC interface module 36 and other stored schedule datasets 300 are not followed.

Storing a plurality of different schedule datasets 300 allows one or more users of the thermostat system 2 to select an in-use schedule dataset 300 that closely fits the habits and/or lifestyles of those one or more users. Stored schedule datasets 300 may differ in that time interval entries representing the same real-world time interval may have different name and/or type fields. For example, where stored schedule datasets 300 each have a calendar form, a day entry being designated as the type “normal” in one schedule dataset 300 may be designated as type “special” or “holiday” in another schedule dataset 300. For example, such differences may be due to different days being holidays in different geographical territories.

One of the plurality of different stored schedule datasets 300 may be initially selected as the in-use schedule dataset 300. For example, the schedule dataset 300 corresponding to the geographic territory where the thermostat system 2 may be initially selected as the in-use schedule dataset 300.

According to various exemplary embodiments, a plurality of schedule datasets 300 may be stored on the local storage device 66 of a thermostat system 2. The schedule datasets 300 may be preloaded when the thermostat system 2 is sold.

According to various exemplary embodiments, a plurality of schedule datasets 300 may be stored on the remote storage device 67 and may be downloaded to the thermostat system 2. This option allows more schedule datasets 300 to be made available to the user for selection as the in-use schedule dataset, including more up-to-date schedule datasets 300.

An initial selection of a stored schedule dataset 300 as an in-use schedule dataset 300 may be made in a user request. The user request may be made by a user interacting with the input device 80 of the thermostat system 2 or using a remote device 6 associated with the thermostat system 2.

The in-use schedule dataset 300 may be stored on the local storage device 66 and/or the remote storage device 67 for retrieval by the controller 32.

The stored in-use schedule dataset 300 may be further modified by the selection of one or more modifier datasets. The modifier datasets define time interval entries that overlap with time interval entries 308 of the in-use schedule dataset 300. Time interval entries of the in-use schedule dataset 300 are further modified based on the selection of one or more modifier datasets.

According to various exemplary embodiments, the one or more modifier datasets may be one or more other schedule dataset 300 having time interval entries that each define time fields, type fields and name fields. For example, selecting at least one other schedule dataset 300 results in a plurality of schedule datasets 300 as in-use schedule datasets.

The one or more modifier datasets may be one or more sets of discrete (i.e. non-continuous) time intervals entries that each define time fields, type fields and name fields. For example, a modifier dataset may define a set of a plurality of time interval entries of the type “special” or “holidays.”

Selection of the one or more modifier datasets causes an overlap in time interval entries defined by the in-use schedule dataset 300 with time interval entries defined in the selected one or more modifier datasets. In particular, for at least one time interval entry of the in-use schedule dataset 300 having a particular time field, the selected at least one modifier dataset will also have a time interval entry having a matching time field.

According to various exemplary embodiments, the in-use schedule dataset 300 and the selected at least one modifier dataset have overlapping time interval entries representing at least two real-world time intervals that are non-contiguous and non-recurring. Non-contiguous real-world time intervals refer to time intervals that are not adjacent. That is, the beginning of the real-world time interval represented by one of the time intervals does not immediately follow the end of the real-world time interval represented by the other of the real-world time intervals. Non-recurring real-world time intervals refer to real-world time intervals that do not occur regularly in time (ex: on a weekly or monthly basis). However, it will be understood that non-recurring real-world time intervals as used herein can refer to time intervals that recur on an annual basis but that is not recurring on a less than annual basis.

Overlaps in time interval entries between the current in-use schedule dataset and the selected at least one modifier dataset are resolved. Resolving an overlap involves determining a single time interval entry to be used by the controller 32 for controlling the HVAC interface module 36 during the real-world time interval identified by the time field of the overlapping time interval entries. According to one exemplary embodiment, resolving an overlap may include choosing the time interval entry of the selected modifier dataset as the time interval entry to be used for the in-use schedule dataset.

Selection of at least one modifier dataset and resolving overlapping time interval entries generates a modified in-use schedule dataset that is followed by the controller 32 for controlling the HVAC interface module 36.

In one exemplary embodiment, time interval entries correspond to days of the year, and the type fields may be “normal” to denote a normal weekday or weekend day or “special” to denote a holiday or another type day that is unlike a normal weekday or weekend. Accordingly, overlaps in time interval entries between the in-use schedule dataset and the selected modifier dataset are resolved so that a time interval entry having the type “special” is set as the time interval entry to be used, thereby overriding the other time interval entry having the type “normal”.

According to various exemplary embodiments, the modifier dataset may be another schedule dataset. Accordingly, the overlapping time interval entries may be contiguous. Overlaps in time interval entries may be resolved according to predetermined field rules. For example, overlaps may be resolved based on type fields. For example, a time interval of one of the schedule datasets of the type other than “normal” overrides the overlapping time interval of the other of the schedule datasets of the type “normal” and is chosen as the time interval of the in-use schedule dataset. For example, where two time intervals are overlapping, the time interval having the type “special” or “custom” is chosen as the time interval of the in-use schedule dataset.

In one example, a first selected schedule dataset may be for a North American territory, wherein time interval for Feb. 8, 2016 is of the type normal. A schedule dataset for an Asian country may then be selected as the modifier dataset. Accordingly, since time interval for Feb. 8, 2016 in the schedule dataset for the Asian country is “Lunar New Year” and has the type “special”, it overrides the time interval of the type “normal” of the first selected schedule dataset for the North American territory. The in-use dataset then uses the time interval of the schedule dataset for the Asian country for Feb. 8, 2016.

According to various exemplary embodiments, a plurality of modifier datasets may be stored on the local storage device 66 of a thermostat system 2. The plurality of modifier datasets may be preloaded when the thermostat system 2 is sold.

According to various exemplary embodiments, a plurality of modifier datasets may be stored on the storage device 67 and may be downloaded to the thermostat system 2. This option allows more modifier datasets 300 to be made available to the user for selection to modify the in-use schedule dataset, including more up-to-date modifier datasets 300. For example, modifier datasets may be ones created or customized by other users, including users that are not associated to the thermostat system 2.

Allowing a user to select one or more modifier datasets to modify an in-use schedule dataset provides for easy customization of the schedule being used for the environmental control of the HVAC system 40. The initial selection of a schedule dataset 300 determines a first schedule that closely fits the habits and/or lifestyle of one or more users of the thermostat system 2. The selection of a modifier dataset further modifies the in-use schedule dataset to even more closely fit the habits and/or lifestyle of the one or more users.

For example, the initial selection of a schedule dataset 300 may be made on the basis of geographical territory. That is, a stored schedule dataset 300 corresponding to the geographical territory where the thermostat system 2 is being used is selected as the in-use schedule dataset. Where the time interval entries correspond to days of the year, this selection may define as type “special” those time interval entries that correspond to holidays in that given geographical territory. The selection of one or more modifier datasets may then be made based on more customized aspects of the one or more users of the thermostat system 2. Such aspects may include cultural identity (ex: religious identity, ethnicity), career status (elementary school student, high school student, university student, working professional, etc.), belonging to a particular organization, etc. Modifier datasets made available for selection may identify such properties and a user may chose the one that is most appropriate.

As described herein, the selection of one or more modifier datasets may result in the modification of one or more time interval entries of the in-use schedule dataset to generate a modified in-use schedule dataset. For example, a modifier dataset configured for an elementary student may result in changing one or more time interval entries of the type “normal” to the type “special”. For example, such days may be pedagogical days for the school that the user attends. Similarly, a modifier dataset configured for a given religion may also result in changing one or more time intervals of the type “normal” to the type “special”. Such days may be important days for that given religion.

According to various exemplary embodiments, the currently in-use schedule dataset (initial in-use schedule dataset or modified in-use schedule dataset) may be further customized on an ad hoc basis. For example, a user may edit properties of a particular time interval entry of the in-use schedule dataset. For example, a user may change a particular time interval entry from the type “normal” to the type “special” (ex: birthday, anniversary, etc.). A user may conversely set a particular time interval entry from type “special” to type “normal” (ex: a religious holiday that is not observed by the user, etc.). Ad hoc customization of the in-use schedule dataset may be carried out by a user making a customization request by interacting with the input device 80 of the thermostat system 2 or using a remote device 6 associated with the thermostat system 2.

One or more environmental control rules datasets may further be stored. The environmental control rules datasets define how the HVAC interface module 36 is to be controlled during real-world time intervals corresponding to time interval entries 308 of the in-use schedule dataset. For example, the environmental control rules datasets may define various setpoints for different time sub-intervals of the real-world time interval defined by a time interval entry.

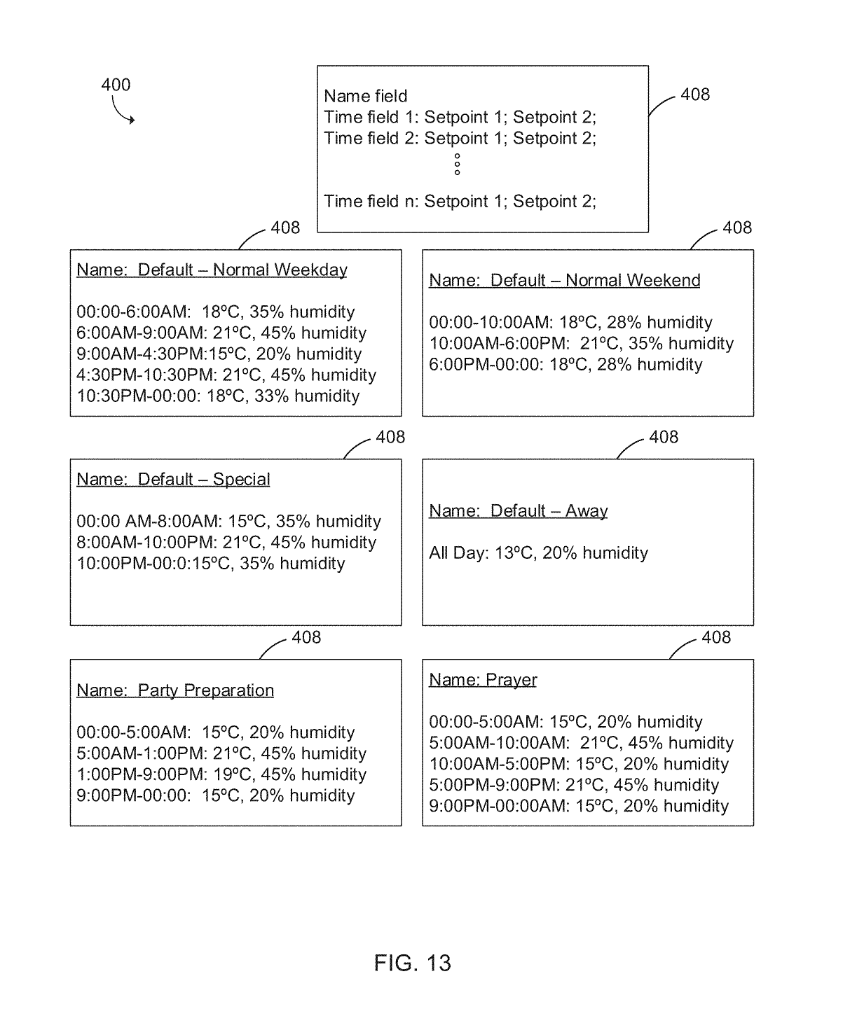

Referring now to FIG. 13, therein illustrated is a schematic diagram of an exemplary data structure 400 for storing environmental control rules datasets 408.

For example, and as illustrated, a first dataset 408 for storing a first set of environmental control rules 408 has a name field: “Normal-Weekday” and a plurality of time sub-interval fields. The plurality of time sub-interval fields define an interval of real-world time and at least one setpoint. The time sub-interval fields may together represent a repeating continuous real-world time interval. In the illustrated example, the time sub-interval fields of each dataset 408 cover the 24 hours of a day.

The setpoints defined in the at least one setpoint field may include at least one of temperature, humidity, use of principal heating device, use of auxiliary heating device, use of principal cooling device, use of auxiliary heating device, etc. In the illustrated examples, the environmental control rules dataset 408 define temperature setpoints and humidity setpoints for each sub-interval field.

The name field of the first dataset 408 may be used to identify the dataset 408. For example, the name field may be used to identify an association of a time entry interval 308 of the in-use schedule dataset with an environmental control rules dataset 408.

Referring back to FIG. 12, each time interval entry 308 is associated to an environmental control rules dataset 408. The association of a time interval entry 308 may be automatically made after an in-use schedule dataset is selected and environmental control rule datasets 408 are defined. The association may be made based on a correspondence of a property of a time interval entry 308 with a property of an environmental control rules dataset 408. For example, and as illustrated, the association may be made between a correspondence between the type field of a time interval entry 308 and the name field of an environmental control rules dataset 408.

According to various exemplary embodiments, a plurality of environmental control rules datasets 408 may be stored on the local storage device 66 of a thermostat system 2. The schedule datasets 408 may be preloaded when the thermostat system 2 is sold.

According to various exemplary embodiments, a plurality of environmental control rules datasets 408 may be stored on the remote storage device 67 and may be downloaded to the thermostat system 2. This options allows more environmental control rules datasets 300 to be made available to the user.

Referring back to FIG. 12, 7 time interval entries 308 are represented in the illustrated example. Of these, time interval entries having the time field “Jan. 14, 2016”, “Jan. 16, 2016”, and “Jan. 19, 2016” each have the type “Normal”. The time interval entries may be further distinguished for weekdays and weekends. These time interval entries may be defined from the initial selection of a schedule dataset 300 as the in-use schedule dataset for controlling the HVAC module interface. After this selection, the three time interval entries are associated to corresponding environmental control rule datasets 408. As illustrated, these are associated to environmental control rule datasets 408 having the names “Normal Weekday” and “Normal Weekend” as appropriate.

Time interval entry having the time field “Jan. 18, 2016” represents the real-world day Jan. 18, 2016. This time interval entry has the name “Martin Luther King Jr. Day” as Jan. 18, 2016 is Martin Luther King Jr. Day in the United States. This time interval entry further has the type “special” since the day is a holiday in the United States. Accordingly, the time interval entry is associated to the environmental control rule dataset having the name “Special”. As a result, the controller 32 will control the HVAC interface module 36 according to the environmental control rules for a “special” day (ex: a holiday) on Jan. 18, 2016. For example, this time interval entry has the type “special” as a result of an initial selection of a schedule dataset 300 for the United States territory (ex: a territory that observes Martin Luther King Jr. Day).

Time interval entry having the time field “Feb. 8, 2016” represents the real-world day Feb. 8, 2016. This time interval entry has the name “Lunar New Year” as Feb. 8, 2016 is the New Year according to the Lunar calendar. This time interval further has the type “special” since it is likely to be observed as a holiday in certain cultures. Accordingly, the time interval entry is associated to the environmental control rule dataset having the name “Special”. As a result, the controller 32 will control the HVAC interface module 36 according to the environmental control rules for a “special” day (ex: a holiday) on Feb. 8, 2016. For example, this time interval entry has the type “special” as a result of the selection of a modifier dataset for a Chinese calendar. Alternatively, other modifier datasets may also denote the Lunar New Year as a “special” type, such as other modifier datasets for other Asian cultures that also observe the Lunar New Year.

Time interval entry having the time field “Jan. 17, 2016” represents the real-world day Jan. 17, 2016. This time interval entry has the name “Jimmy's birthday”. For example, the time interval entry may have been added as a result of an ad hoc customization request made by a user. For example, a user may have made a request to specify that the time interval entry corresponding to Jan. 17, 2016 has the name Jimmy's Birthday and that it is of the type “party preparation”. As indicated, the time interval entry is associated to the environmental control rule dataset having the name “Party preparation”.

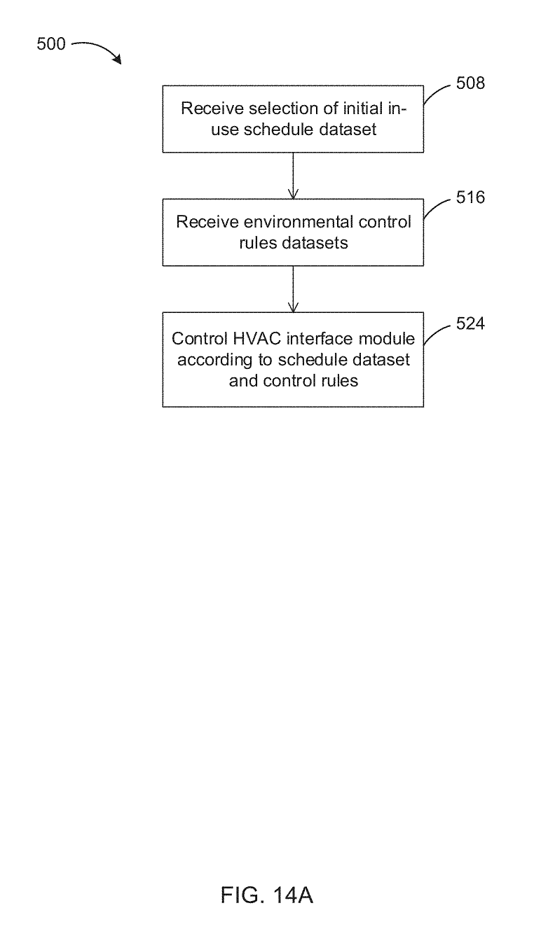

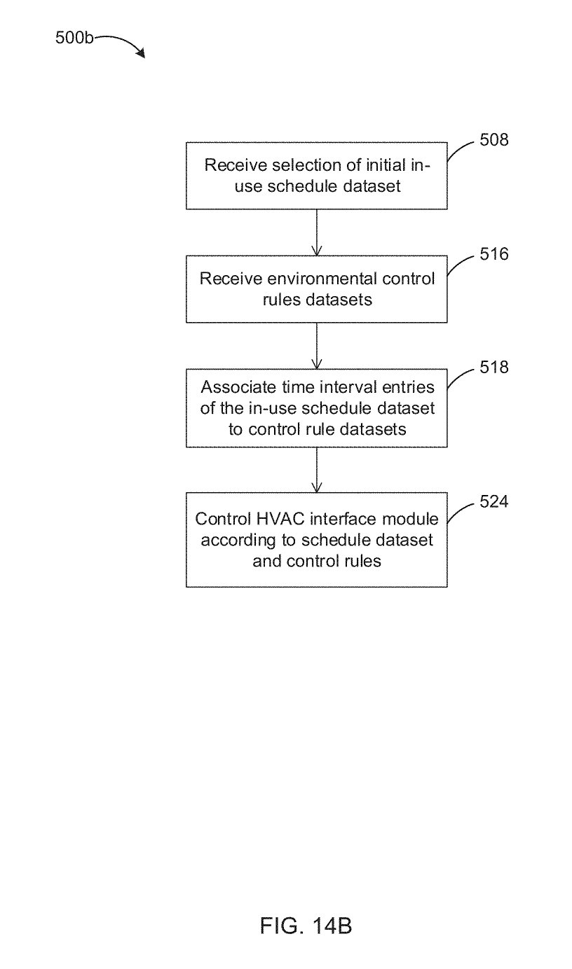

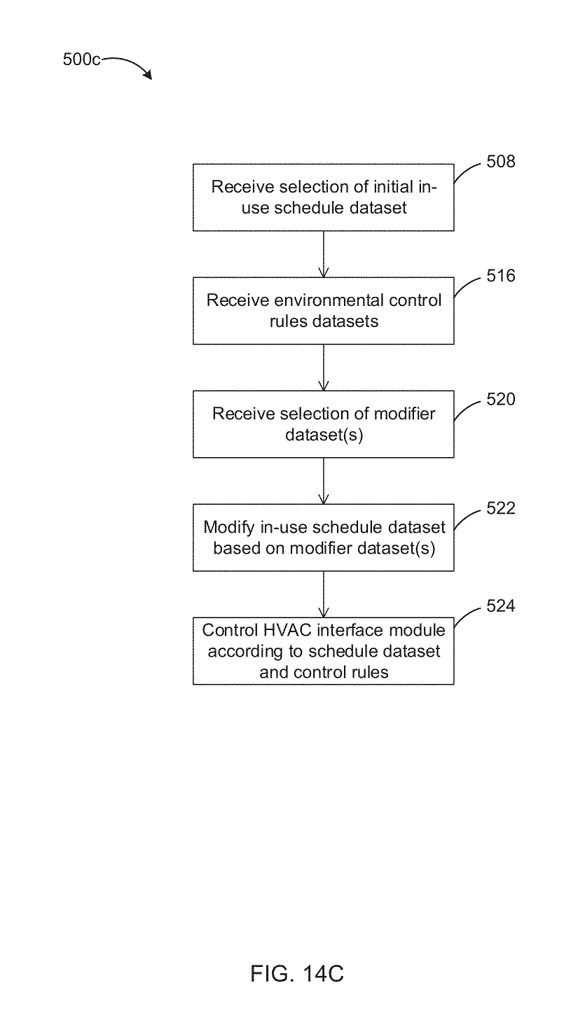

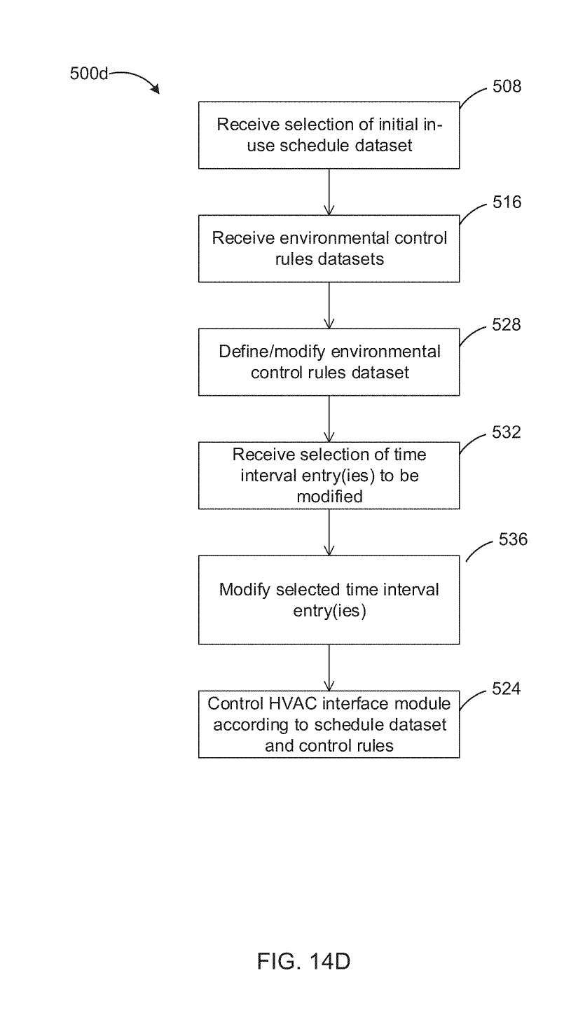

Referring now to FIG. 14A, therein illustrated is a flowchart showing the operational steps of an example method 500 for controlling the HVAC system 40. The example method 500 may be carried out on the controller 32 of the thermostat system 2.

At step 508, a selection of an initial schedule dataset is received. As described elsewhere herein, a plurality of schedule datasets are stored locally and/or remotely. These schedule datasets may be presented to a user, such as via the display of the thermostat system 2 or on the display of a remote device 6 associated to the thermostat system 2. The user may then select one of the schedule datasets 300 as the initial in-use schedule dataset. This selection is received at the controller 32.

At step 516, environmental control rules are received. As described elsewhere herein, a plurality of environmental control rules are stored as datasets 408 locally and/or remotely. The environmental control rules datasets may be preloaded onto the thermostat system 2 and stored on the local storage device 66, downloaded from a remote storage device 67 and/or defined through a user interacting with the thermostat system 2. For example, receiving the environmental control rules includes retrieving the appropriate datasets 408 from the appropriate storage device.

At step 524, the HVAC interface module 36 is controlled based on the in-use schedule dataset and the received environmental control rules datasets. For example, a time interval entry 308 of the in-use schedule dataset corresponding to the current real-world time is received. The environmental control rules dataset 408 associated to that time interval entry 308 is further retrieved. A given time sub-interval field of the environmental control rules dataset 408 corresponding to the current real-world time is further received. The controller 32 then transmits signals to the HVAC interface module 36 to configure one or more setpoints of the HVAC system 2 according to the one or more setpoint entries defined in the setpoint fields of the given time sub-interval field of the environmental control rules dataset 408.

Referring now to FIG. 14B, therein illustrated is a flowchart showing the operational steps of an example method 500B for controlling the HVAC system 40. The example method 500B may be carried out on the controller 32 of the thermostat system 2. Exemplary method 500B includes the steps 508, 516 and 524 as described above, but further includes the step 518.

At step 518, each of a plurality of time interval entries are associated to one of the environmental control rule datasets 408 received at step 516. The association may be made based on a property of the time interval entries (ex: type) and a property of the environmental control rule datasets 408 (ex: name/identifier).

Referring now to FIG. 14C, therein illustrated is a flowchart showing the operational steps of an example method 500C for controlling the HVAC system 40. The example method 500C may be carried out on the controller 32 of the thermostat system 2.

Exemplary method 500C includes the steps 508, 516 and 524 as described above, but further includes the steps 520.

At step 520, a selection of at least one modifier dataset is received. As described elsewhere herein, a plurality of modifier datasets are stored locally and/or remotely. These modifier datasets may be presented to a user, such as via the display of the thermostat system 2 or on the display of remote device 6 associated to the thermostat system 2. The user may then select one or more of the modifier datasets for modifying the current in-use schedule dataset. This selection of the modifier dataset is received at the controller 32.

At step 522, the current in-use schedule dataset is modified based on the selected at least one modifier dataset. As described elsewhere herein, the in-use schedule dataset may be modified in that properties of time interval entries of the current in-use schedule dataset may be changed. For example, the modifier dataset may also define a plurality of time interval entries. Overlaps between time interval entries of the in-use schedule dataset and time interval entries of the modifier dataset are resolved. As a result of the in-use schedule dataset being modified, association of one or more time interval entries with environmental control rules datasets may also be changed.

At step 524, the HVAC interface module 36 may be controlled according to the in-use schedule dataset as modified by the selected at least one modifier dataset.

Referring now to FIG. 14D, therein illustrated is a flowchart showing the operational steps of an example method 500d for controlling the HVAC system 40. The example method 500d may be carried out on the controller 32 of the thermostat system 2.

Exemplary method 500d includes the steps 508, 516 and 524 as described above, but further includes the steps 528, 532, and 536.

At step 528, a request to define a new environmental control rules dataset or modify a currently stored environmental control rules dataset is received. The request may be made by a user, such as via the input device 80 of the thermostat system 2 or via a remote device 6 associated to thermostat system 2. Defining a new environmental control rules dataset or modifying a currently stored environmental control rules dataset includes defining or modifying at least one time sub-interval of the rules dataset. It may also include defining or modifying at least one setpoint field for at least one time sub-interval.

At step 532, a selection of at least one time interval entry to be modified is received. The selection may also indicate how the at least one time interval entry is to be modified. The selection may be made by a user, such as via the display of the thermostat system 2 or on the display of a remote device 6 associated to thermostat system 2. For example, the association of the at least one time interval entry with a particular environmental control rules dataset may be modified. For example, the selected at least one time interval entry is modified so as to be associated with the environmental control rules dataset newly defined or modified at step 528.

At step 536, the selected at least one time interval entry is modified according to the modification request. For example, one or more fields of the selected at least one time interval entry may be modified. For example, as a result of the modification, the selected at least one time interval entry may be associated to a different environmental control rules dataset.

It will be understood that according to various exemplary embodiments, step 528 may be optional while steps 532 and 536 are carried out. For example, a particular time interval entry may be selected and the type of the time interval entry may be modified, thereby causing the time interval to be associated to a different environmental control rules dataset. It will be appreciated that this causes the controller 32 to carry out a different environmental control during the real-world time interval corresponding to the particular time interval entry. This may be one form of ad hoc customization.

Referring back to FIG. 12, this may be the case for time interval entry having the time “Jan. 17, 2016”, wherein the time interval was specifically selected and modified to have the name “Jimmy's Birthday” and the type “Party preparation”. As a result, the time interval entry becomes associated to the environmental control rules datasets having the identifier “Party preparation”. This corresponds to steps 532 and 536. Step 528 may also be carried out to first define the rules dataset having the identifier “Party preparation”.

It will be understood that according to various exemplary embodiments, steps 532 and 536 may be optional while step 528 is carried out. It will be appreciated that modifying a particular environmental control rules datasets will cause the controller 32 to carry out a different environmental control scheme during one or more real-world time intervals defined by the time interval entries associated to that particular environmental control rules dataset. For example, this may be useful for modifying the environmental control rules for a class of events, such as all time interval entries of the same type.

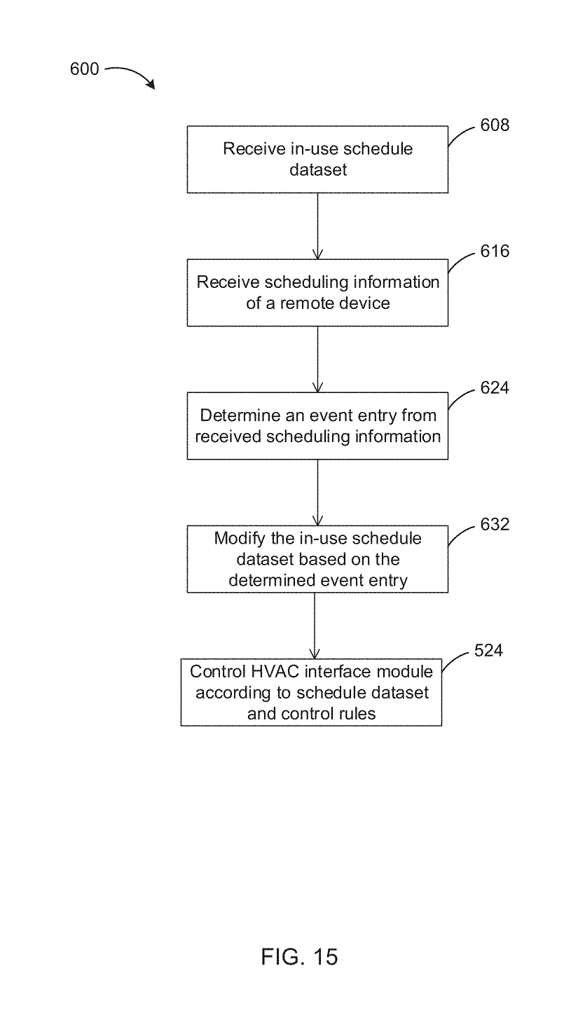

Referring now to FIG. 15, therein illustrated is a flowchart showing the operational steps of an example method 600 for controlling the HVAC system 40. The example method 600 may be carried out on the controller 32 of the thermostat system 2, on the processor 68 of the scheduling service provider 7 or steps may be split between the processor 68 and the controller 32.

At step 608, the in-use schedule dataset is received. The in-use schedule dataset may be the initially selected schedule dataset (ex: step 508) or the modified schedule data set (ex: 522).

At step 616, scheduling information stored on a remote device 6 is received. The remote device 6 may be registered with the thermostat system 2 (e.g. either directly or via a server) in that at least one identifier of each of the registered remote devices 6 are known to the thermostat system 2 so as to permit the thermostat system 2 to communicate with the registered remote devices 6. For example, and as illustrated, the at least one remote device 6 includes a smartphone/tablet and a personal computer. The scheduling information corresponds to a schedule that is stored on the remote device 6 or at a remote storage device registered with the remote device 6 (ex: cloud-based storage).

The scheduling information is typically used by a user of the remote device 6 to track various events associated to the user, such as meetings, reminders, or other events that the user has to tend to. Such scheduling information is not directly related to environmental control of the building with the thermostat system 2.

At step 624, an event entry is determined from the received scheduling information. The event entry is a data entry representing an event that the user has entered into the remote device 6 or that has been generated by the remote device 6 or a cloud-based service associated to the remote device 6. For example, the event entry may include information regarding the event, such as type (meeting, reminder, vacation, etc.), location, time, and participants.

At step 632, where appropriate, the in-use schedule dataset for controlling the HVAC interface module 36 may be modified based on the event entry determined 624. A modification may be made where it is determined that the event entry determined at step 632 is relevant to the in-use schedule dataset. The relevance may be determined from the event entry information, such as type, location, time and/or participants.

At step 524, the HVAC interface module 36 may be controlled according to the in-use schedule data set as modified by the selected at least one modifier dataset and/or as modified based on the event entry determined at step 624.

According to one exemplary embodiment, the in-use schedule data set is modified based on whether the event entry will cause a user to be away from the building having the HVAC system 40. If the event entry will cause a user to be away, the in-use schedule dataset may be modified according to the time interval for which the user will be away.

In some other exemplary embodiments, the status of other residents or tenants of the building is also checked for the time interval of the event entry that will cause the user to be away. Accordingly, the in-use schedule dataset is modified for the time interval only if all residents or tenants of the building will also be away for that time interval.

Referring back to FIG. 12, the time interval entry having the time “Jan. 15, 2016” may have been modified based on an event entry determined from scheduling information of a remote device 6. For example, an initially selected schedule dataset 300 as the in-use schedule dataset 300 included a time interval entry for Jan. 15, 2016 that was of the type normal. Subsequently, a user entered into the scheduler of a remote device 6 an event entry for a trip on Jan. 15, 2016. This information is received at step 616 and the event entry is determined at step 624. It is further determined that a user of the thermostat system 2 is likely to be away on Jan. 15, 2016. Accordingly, at step 632, the time interval entry corresponding to real-world time interval Jan. 15, 2016 is changed to the type “Away” such that environmental control rules dataset identified as “Away” will be applied to Jan. 15, 2016.

According to various exemplary embodiments, the thermostat system 2 may further transmit an alert that includes information regarding an upcoming time interval entry of the in-use schedule dataset. The alert may be for a time interval entry representing a real-world time interval that will occur in the future. The alert may act as reminder. The alert may be displayed on the display 88 or transmitted as an electronic message to one or more remote devices 6 associated to the thermostat system 2.

The alert may further prompt the user to input at least one environmental control rule modification request. The request may be received and may correspond to step 528 as described herein. After receiving the modification request, the stored environmental control rules dataset may be modified according to parameters identified in the request.

It will be appreciated that the alert may act as a reminder to one or more users of the thermostat system 2. For example, an alert may be given for each upcoming time interval entry of a type other than “normal”. Accordingly, the user is prompted to select environmental control rules for the upcoming real-world time interval represented by the time interval entry.

According to various exemplary embodiments, a given time interval entry may be associated to an environmental control rules dataset based on type and at least one other property. For example, the at least one other property may be time of year. For example, there may be different environmental control rules datasets for time interval entries of the “normal” type, the appropriate rules dataset being applied based on time of year that the time interval entry represents. For example, there may be different environmental control rules for different seasons. For example, environmental control rules datasets for winter season may have heating calls (ex: to use a heating system) while rules datasets for summer season may have cooling calls.

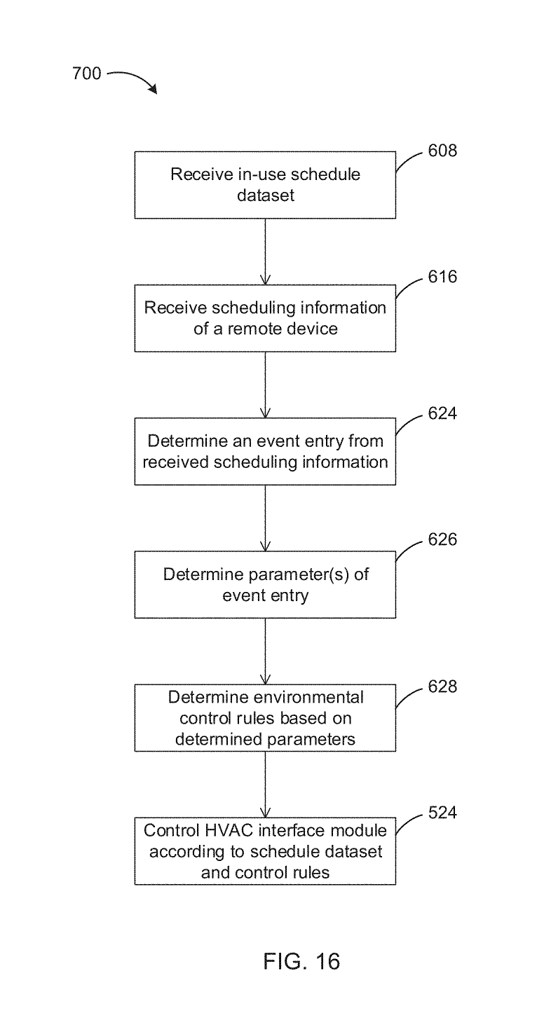

Referring now to FIG. 16, therein illustrated is a flowchart showing the operational steps of an example method 700 for controlling the HVAC system 40. The example method 700 can be carried out on the controller 32 of the thermostat system 2, on the processor 68 of the updating service provider 7 or steps may be split between the processor 68 and the controller 32. Exemplary method 700 includes the steps 608, 616 and 624 as described above but further includes the steps 626 and 628.

At step 626, at least one parameter of the event entry is determined. For example, the parameter may include a start time and end time and location of the event entry. For example, from the parameters, it may be determined the time a user will be away from the HVAC system and a time a user will be in proximity of the HVAC system.

At step 628, the environmental control rules dataset associated to the time interval entry corresponding to the times of the determined event entry may be modified. For example, custom environmental control rules dataset may be determined to override the environmental control rules dataset previously associated to the time interval entry of the in-use schedule dataset. For example, time sub-interval fields and set point fields may be set to correspond to the parameters determined at step 626, such as the times the user will be away from the building and the user will be in proximity of the building.

At step 524, the control of the HVAC interface module 36 is carried out based on the environmental control rules modified and/or customized at step 628.

It will be understood that exemplary steps of methods 500a to 500d, 600 and 700 may be combined in different ways according to various exemplary embodiments.

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

1. A method for controlling a HVAC system, the method comprising:
receiving selection of an in-use schedule data set;
receiving environmental control rules; and
controlling a HVAC interface module of the HVAC system based on the in-use schedule dataset and the environmental control rules,
wherein the in-use schedule dataset defines a plurality of time interval entries each defining an interval of real-world time;
wherein the environmental control rules comprises a plurality of environmental control rule datasets each defining at least one control setpoint for at least one sub-interval of time;
and wherein the processor is further configured for associating each of the plurality of time interval entries to one of the environmental control rule datasets; and
wherein controlling the HVAC interface module comprises controlling the HVAC interface module during a given interval of real-world time defined by a given time interval entry according to the environmental control rule dataset associated to that given time interval entry.

2. The method of claim 1, further comprising:
receiving a selection of a modifier dataset;
modifying the in-use schedule dataset based on the selected modifier dataset; and
wherein controlling the HVAC interface module is based on the in-use schedule dataset as modified based on the selected modifier dataset.

3. The method of claim 2, wherein the modifier dataset defines modifications to at least two non-contiguous and non-recurring time periods of the base schedule.

4. The method of claim 3, wherein the in-use schedule defines a plurality of normal days and a plurality of special days;
wherein the at least two non-contiguous and non-recurring time periods defines at least two special days;
wherein modifying the base schedule comprises adding the at least two special days to the in-use schedule; and
wherein the environmental control rules comprises a first set of rules for controlling the HVAC system on normal days and a second set of rules for controlling the HVAC system on special days.

5. The method claim 1, wherein the schedule modifier defines important days associated to one or more of religion, cultural identity, organization, and career status.

6. The method of claim 1, further comprising:
receiving a user customization request for customizing a time interval entry of the in-use schedule dataset; and
modifying the in-use schedule based on the received user customization request.

7. The method of claim 6, wherein the customization request defines at least one special day and wherein modifying the in-use schedule comprises changing the type field of the time-interval entry to special.

8. The method of claim 1, further comprising:
transmitting an alert comprising information regarding an upcoming time interval entry defined by the in-use schedule dataset, the time interval entry defining a real-world time interval; and
receiving at least one environmental control rule modification request for modifying the environmental control rules for the real-world time interval.

9. The method of claim 8, wherein the alert is transmitted on a display of the thermostat system or as an electronic message via at least one of the wide-area communication module and the local communication module; and
wherein the alert comprises a prompt for a user to input the at least one environmental control rule modification request.

10. The method of claim 1, wherein the environmental control rules comprise different control sub-rules associated to different contiguous intervals of a year.

11. A method for controlling a HVAC system, the method comprising:
receiving a currently-in-use schedule;
receiving environmental control rules for controlling the HVAC system;
receiving via at least one of a wide-area communication module and a local communication module schedule information of a remote device associated to the thermostat system;
determining from the received schedule information an event entry;
modifying the currently-in-use schedule based on the determined event entry, thereby generating a modified currently-in-use schedule; and
controlling an HVAC interface module based on the modified currently-in-use schedule and the environmental control rules.

12. The method of claim 11, wherein the event entry is an entry made to a schedule stored on the remote device.

13. The method of claim 11, further comprising:
determining environmental control sub-rules based on the determined event entry; and
controlling the HVAC interface module according to the environmental control sub-rules during an interval of time defined by the event entry.

14. The method of claim 13, further comprising:
determining from the event entry a time a user will be away from the HVAC system and a time a user will be in proximity of the HVAC system; and
wherein the environmental control sub-rules are determined based on the time the user will be away and the time the user will be in proximity.

15. The method of claim 14, wherein determining the environmental control sub-rules comprises setting an environmental control instruction for a time before the time user will be in proximity.

16. A non-transitory computer readable medium comprising a plurality of instructions for performing a method for controlling a HVAC system, wherein the instructions, when executed, configure a processor to perform the method claim 1.
